(19) United States
(12) Patent Application Publication
(10) Pub. No.: US 2021/0074999 A1
(43) Pub. Date: Mar. 11, 2021

(54) Systems and Methods of Making Solid-State Batteries and Associated Solid-State Battery Anodes

(71) Applicant: TeraWatt Technology Inc., Santa Clara, CA (US)

(72) Inventors: Hiroshi Imoto, Kanagawa (JP); Yang Yang, Kanagawa (JP)

(73) Assignee: TeraWatt Technology Inc., Santa Clara, CA (US)

(21) Appl. No.: 16/561,113

(22) Filed: Sep. 5, 2019

(51) Int. Cl. H01M 4/133; H01M 4/1393; H01M 4/36; H01M 4/587; H01M 4/62; H01M 10/0525; H01M 10/0562; H01M 4/04

(52) U.S. Cl. CPC H01M 4/133; H01M 4/1393; H01M 4/366; H01M 4/587; H01M 2004/027; H01M 10/0525; H01M 10/0562; H01M 4/043; H01M 4/0419; H01M 4/625

(57) ABSTRACT

Various embodiments and methods related to solid-state battery and associated solid-state battery anodes are presented. The solid-state battery may include a solid-state battery cathode, a solid-state battery anode, and a solid electrolyte separator. The solid electrolyte separator may be positioned between the solid-state battery cathode and the solid-state battery anode to form the solid-state battery. The solid-state battery anode may include a second solid electrolyte powder, a plurality of graphite particles, and a plurality of conductive fibers. The plurality of conductive fibers may be interspersed between the plurality of graphite particles. The plurality of graphite particles may be characterized by a D50 diameter of less than 20 μm. The plurality of graphite particles may be coated with a solid-state interfacial coating. The solid-state interfacial coating may include a low-crystallinity carbon.

### BACKGROUND

As battery technology has become more advanced so have the use of batteries within electric vehicles (EV). In some instances, such as commuter vehicles, EVs aim to replace traditional gas-combustion vehicles as EVs offer a more environmental friendly solution. However, in order for EVs to eventually replace gas-combustion vehicles, EVs must be able comparably operate. One possible drawback of EVs is their reduction in driving range and temperature sensitivity, especially in cold conditions. Limiting weight and space requirements of EVs restrict the amount of batteries onboard EV. Moreover, current battery-technology used with EVs pose safety concerns due to the exothermic and combustible nature of the batteries. Hence, energy capacity, safety, and size are important properties of batteries within EVs. Therefore, there is a need for improved energy capacity, safety and size requirements of batteries within EVs.

### SUMMARY

Various embodiments are described related to solid-state battery and associated solid-state battery anodes. The solid-state battery may include a solid-state battery cathode and a solid-state battery anode. In some embodiments, the solid-state battery cathode may include a first solid electrolyte powder and a plurality of cathode particles mixed with the first solid electrolyte powder to form the solid state battery cathode. The solid-state battery anode may include a second solid electrolyte powder, a plurality of graphite particles, a solid-state interfacial coating, and a plurality of conductive fibers. The plurality of graphite particles may be characterized by a D50 diameter of less than 20 μm. The solid-state interfacial coating may include a low-crystallinity carbon and may be coated onto the plurality of graphite particles. The plurality of conductive fibers may be interspersed between the plurality of graphite particles within the solid-state battery anode. In some embodiments, the conductive fibers may include vapor grown carbon fibers.

The solid-state battery may also include a solid electrolyte separator. The solid electrolyte separator may be positioned between the solid-state battery cathode and the solid-state battery anode to form the solid-state battery. In some embodiments, the solid electrolyte separator may have a thickness of from about 50 μm to about 100 μm. Optionally, the solid-state battery anode may have a thickness from about 15 μm to about 100 μm.

A solid-state battery anode may also be described herein. The solid-state battery anode may include a solid electrolyte powder. In some embodiments, the solid electrolyte powder may consist of at least one of a polymer solid-state electrolyte, an inorganic solid-state electrolyte, or a sulfur based electrolyte. Optionally, the solid electrolyte powder may include lithium phosphorus sulfide. In some embodiments, the solid-state battery anode may include from about 10 wt. % to about 40 wt. % of the solid electrolyte powder. The solid-state battery anode may also include a plurality of graphite particles mixed with the solid electrolyte powder to form a solid-state battery anode. The plurality of graphite particles may be characterized by a D50 diameter of less than 20 μm. In some embodiments, the solid-state battery anode may include from about 50 wt. % to about 85 wt. % of the plurality of graphite particles. Optionally, the plurality of graphite particles may include meso-carbon microbeads. In some embodiments, the plurality of graphite particles may be characterized by a spherical shape.

The solid-state battery anode may also include a solid-state interfacial coating. The solid-state interfacial coating may include a low-crystallinity carbon. The solid-state interfacial coating may be coated onto the plurality of particles to reduce interfacial reactivity between the plurality of graphite particles and the solid electrolyte powder within the solid-state battery anode. The solid-state battery anode may also include a plurality of conductive fibers. For example, the plurality of conductive fibers may include carbon or graphite fibers. The plurality of conductive fibers may be interspersed between the plurality of graphite particles within the solid-state battery anode. In some embodiments, at least 25% of the plurality of graphite particles may be contacted by the conductive fibers. Optionally, the solid-state battery anode may include from about 0 wt. % to about 5 wt. % of the plurality of conductive fibers.

In some embodiments, the solid-state battery anode may be part of a half-cell assembly. In some embodiments, the half-cell assembly including the solid-state battery anode may have a discharge capacity greater than about 200 mAh/g. Optionally, the half-cell assembly including the solid-state battery anode may have an initial coulombic efficiency greater than about 50 %.

A method of manufacturing a solid-state battery anode may also be described herein. The method may include providing a graphite powder for a solid-state battery anode and filtering the graphite powder to form a plurality of graphite particles. The plurality of graphite particles may be characterized by a D50 diameter of less than 20 μm. The method may also include coating the plurality of graphite particles with a solid-state interfacial coating. In some embodiments, coating the plurality of graphite particles may include spray coating the plurality of graphite particles with a low-crystallinity carbon in a fluidized bed. The method may also include mixing a solid electrolyte powder with the plurality of graphite particles. In some embodiments, mixing the solid electrolyte powder with the graphite particles may include dissolving the solid electrolyte powder in an electrolyte solvent to form an electrolyte solution. The graphite particles may be soaked in the electrolyte solution to form an anode solution. The anode solution may be dried.

The method may also include providing a plurality of conductive fibers. The conductive fibers may be mixed with the solid electrolyte powder and the plurality of graphite particles to form a dry anode mixture. The dry anode mixture may be pressed to form the solid-state battery anode.

### BRIEF DESCRIPTION OF THE DRAWINGS

FIG. 1 illustrates a conventional lithium-ion battery according to some embodiments as disclosed herein.

FIG. 2 illustrates a solid-state battery according to some embodiments as disclosed herein.

FIG. 3A illustrates a solid-state battery anode having large graphite particles according to some embodiments as disclosed herein.

FIG. 3B illustrates a solid-state battery anode according to some embodiments as disclosed herein.

FIG. 4A illustrates interfacial reactions occurring within a solid-state battery anode according to some embodiments as disclosed herein.

FIG. 4B illustrates a solid-state battery anode according to some embodiments as disclosed herein.

FIG. 5A illustrates an electron pathway within a solid-state battery anode lacking conductive fibers according to some embodiments as disclosed herein.

FIG. 5B illustrates an electron pathway within a solid-state battery anode including conductive fibers according to some embodiments as disclosed herein.

FIG. 6 illustrates a method of making a solid-state battery anode according to some embodiments as disclosed herein.

### DETAILED DESCRIPTION

Described herein, are embodiments for a solid-state battery and corresponding solid-state battery anode. Sustainable energy as well as efficient and economical energy conversion and storage technologies have become important work in light of the rising environmental issues. Electrical energy storage technologies play a significant role in the demand for green and sustainable energy. Specifically, rechargeable batteries or secondary batteries, such as lithium-ion batteries, which allow for reversible conversion between electrical and chemical energy have been increasingly relied upon by numerous technologies requiring portable and uninterrupted power sources.

One industry that has been driving the demand for improved rechargeable batteries is the automobile industry. As environmental concerns shift vehicles from combustion-based to electric-based, there is a growing demand for battery having high capacity and cyclability capabilities while reducing size and providing safe power. Presently, electric vehicles (EVs) typically utilize conventional lithium-ion batteries. However, conventional lithium-ion batteries have a few drawbacks. Pure EVs have yet to achieve cost parity with combustion-based vehicles, due in large part to battery cost and range capabilities. Both of these issues are significantly dependent on the battery energy density (i.e., capacity). Conventional lithium-ion batteries have limited energy density and thus to be utilized in EVs, larger volumes of batteries are typically required. Moreover, conventional lithium-ion batteries, especially those that use organic liquid electrolytes, suffer from problems of flammability, low ion selectivity, limited electrochemical stability, and reasonably short lifespans.

Solid-state lithium batteries show potential to mitigate these issues by replacing the liquid or gel electrolyte with a solid-state electrolyte. Solid-state batteries are widely accepted as promising candidates for next generation of batteries, especially for use in EVs, due to high energy density potential and superior safety performance. However, the energy density, rate capacity, and capacity retention of solid-state batteries remains poor, impeding their ultimate commercial usage. These poor properties are caused, in part, by high resistance at the electrode/electrolyte interface. High interfacial resistivity may be caused by a variety of factors, including (1) interfacial reactions between the solid-state electrode and solid-state battery anode, (2) electrochemical decomposition of the solid-state electrolyte at the interface during cell cycling, and (3) poor interfacial contact between the solid-state electrolyte and the solid-state battery anode. Accordingly, as provided herein, the performance, specifically the capacity, of solid-state batteries may be improved by reducing the interfacial resistance between the solid-state battery anode and the solid-state electrolyte.

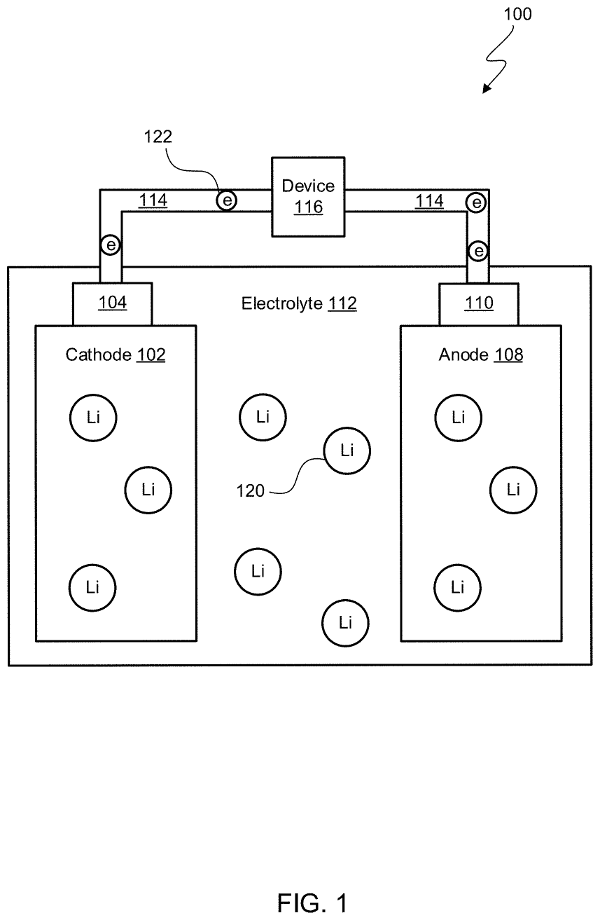

Further detail regarding such embodiments and additional embodiments is provided in relation to the figures. FIG. 1 depicts a conventional battery 100 that may be implemented by one or more embodiments. Conventional battery 100 may be a lithium-ion battery and produce electrical energy through electrochemical and/or chemical reactions. Conventional battery 100 may be a rechargeable battery (i.e., secondary battery) having reversible electrochemical capabilities such to allow for repeated charging and discharging cycles of conventional battery 100.

Conventional battery 100 may include a cathode 102, an anode 108, and an electrolyte 112. Conventional battery 100 may also include an electron path 114, and two terminals (current collectors) 104 and 110. The arrangement of conventional battery 100 and respective components may vary depending on the configuration of conventional battery 100. Cathode 102 may be a positive electrode and anode 108 may be a negative electrode. Cathode 102 may, prior to the initiation of a charging process, contain a plurality of lithium ions 120 (e.g., positively charged lithium ions; Li⁺). During the charging process, the lithium ions 120 intercalated within cathode 102 may flow, via electrolyte 112, to anode 108. During the discharging process the opposite may take place and lithium ions 120 intercalated within anode 108 may flow, via electrolyte 112, back to cathode 102.

As used herein, the terms intercalation, intercalated, and intercalate, may refer to a reversible inclusion or insertion of an ion (e.g., lithium ions 120) into a material having a layered or crystalline structure (lattices), such as anode 108 or cathode 102. Similarly, the terms deintercalation, deintercalated, and deintercalate, may refer to the reversible exclusion or expulsion of an ion (e.g., lithium ions 120) out of a material having a layered or crystalline structure (lattices).

Terminal 104 may be a current collector attached to cathode 102. Terminal 104 may be a positive current collector. Terminal 110 may be a current collector attached to anode 108. Terminal 110 may be a negative current collector. Terminals 104 and 110 may include various materials including, but not limited to, aluminum, nickel coated steel, and/or compounds based on aluminum, nickel, or any other suitable metal. During the charging process, when lithium ions 120 within cathode 102 flow from the cathode 102 to anode 108, electrons 122 may be “released.” Electrons 122 may flow from cathode 102 to terminal 104 and then from terminal 104, via electron path 114, to terminal 110. Because current flows in the opposite direction of electrons, terminal 104 may collect current during the charging process.

Electrolyte 112 may separate cathode 102 and anode 108 and prevent the electrodes from directly contacting one another. During the charging and discharging cycles, electrolyte 112 separating the cathode 102 and the anode 108 may prevent electron flow between the electrodes. By preventing electron flow between the anode 108 and the cathode 102, the electrons 122 may be forced to flow via electron path 114. Electron path 114 may be a path through which electrons 122 flow between cathode 102 and anode 108 because the electrons 122 cannot flow through electrolyte 112.

In some embodiments, device 116 may be attached to electron path 114 and during a discharging process electrons 122 flowing through electron path 114 (from anode 108 to cathode 102) may power device 116. In some embodiments, device 116 may only be attached to electron path 114 during a discharge process. In such embodiments, during a charging process when an external voltage is applied to conventional battery 100, device 116 may be directly powered or partially powered by the external voltage source.

Device 116 may be a parasitic load attached to conventional battery 100. Device 116 may operate based at least in part off of power produced by conventional battery 100. Device 116 may be various devices such as an electronic motor, a laptop, a computing device, a processor, and/or one or more electronic devices. Device 116 may not be a part of conventional battery 100, but instead relies on conventional battery 100 for electrical power. For example, device 116 may be an electronic motor that receives electric energy from conventional battery 100 via electron path 114 and device 116 may convert the electric energy into mechanical energy to perform one or more functions such as acceleration in an EV. During a charging process, when an external power source is connected to conventional battery 100, device 116 may be powered by the external power source (e.g., external to conventional battery 100). During a discharging process, when an external power source is not connected to conventional battery 100, device 116 may be powered by conventional battery 100.

Electrolytes, such as electrolyte 112, play a key role in transporting the lithium ions 120 between the cathode 102 and the anode 108. To allow movement of the lithium ions 120, electrolyte 112 needs to be conductive. In conventional lithium-ion batteries, such as conventional battery 100, the electrolyte 112 may be a liquid electrolyte. Liquid electrolytes typically have higher ionic conductivity than solid electrolytes. In some embodiments, electrolyte 112 may include soluble salts, acids or other bases in liquid or gelled formats. Exemplary electrolytes 112 may include a solution of lithium salts with organic solvents such as ethylene carbonate.

In addition to conductivity, ion diffusion between the electrolyte 112 and electrodes (i.e., anode 108 and cathode 102) is another important electrochemical property of an electrolyte. Interfacial contact between the electrolyte 112 and the electrodes must be adequately maintained to allow for ion diffusion. If there is a gap between the electrodes and electrolyte 112 (i.e., or poor interfacial contact), then the interfacial resistivity may be high and ion diffusion may be difficult. When the interfacial resistivity is high, then transfer of lithium ions 120 between the electrodes and electrolyte 112, and vice versa, may be impacted resulting in reduced battery capacity.

Liquid electrolytes, such as electrolyte 112, may be advantageous because of the ability of the liquid electrolyte to initiate and maintain intimate interfacial contact between electrolyte 112 and the electrodes (anode 108 and cathode 102). As illustrated in FIG. 1, anode 108 and cathode 102 are typically submerged in electrolyte 112 to enhance wetting (i.e., contact) of the electrodes. With a liquid electrolyte, the electrolyte may saturate the electrode structure, allowing for electrolyte 112 to penetrate into the electrode and access ions stored deep within the electrode structure. However, liquid electrolytes pose numerous safety concerns.

The format of electrolyte 112, whether it be liquid or gel, may require conventional battery 100 to have a large volume as well as be liquid tight. Liquid electrolytes, such as electrolyte 112, may have low thermal stability. Typically utilized liquid electrodes include combustible liquids such as organic carbonate esters or toxic lithium salts. Thus, any leakage of electrolyte 112 may be hazardous and pose safety concerns, especially when conventional battery 100 is used in EV applications.

Dendrite formation may also be problematic for electrolyte 112. Dendrites are branch-like growths of lithium metal, which occurs when lithium ions collect in localized areas on the electrode surface. During the charging cycle, lithium ions 120 move from cathode 102 to anode 108 and distribute unevenly on the surface of anode 108. With each subsequent charging cycle, lithium ions 120 find a path of least resistance, causing them to collect in localized areas that protrude from the surface of anode 108. These protrusions can grow long enough to span the distance between the electrodes, causing an internal electrical short circuit which may result in battery failure. Furthermore, short-circuiting often causes localized heating and, when using a liquid electrolyte with low thermal stability, that heat can quickly accelerate the onset of thermal runaway, which can lead in some cases to combustion of conventional battery 100.

Replacing liquid electrolytes, such as electrolyte 112, with a solid electrolyte may address the numerous issues posed by conventional battery 100. First, solid electrolytes have higher thermal stability, meaning that flammability concerns are reduced. Second, since solid electrolytes are solid, leakage and storage concerns are mitigated. Moreover, solid electrolytes allow for the overall size of the solid-state battery to be reduced as compared to conventional lithium-ion batteries because of the increased energy density of solid-state batteries. Third, solid electrolytes can physically suppress dendrite growth and alleviate the corresponding safety concerns. Overall, solid electrolytes can improve battery safety and performance due to their superior mechanical, electrochemical, and thermal stability when compared with liquid electrolytes.

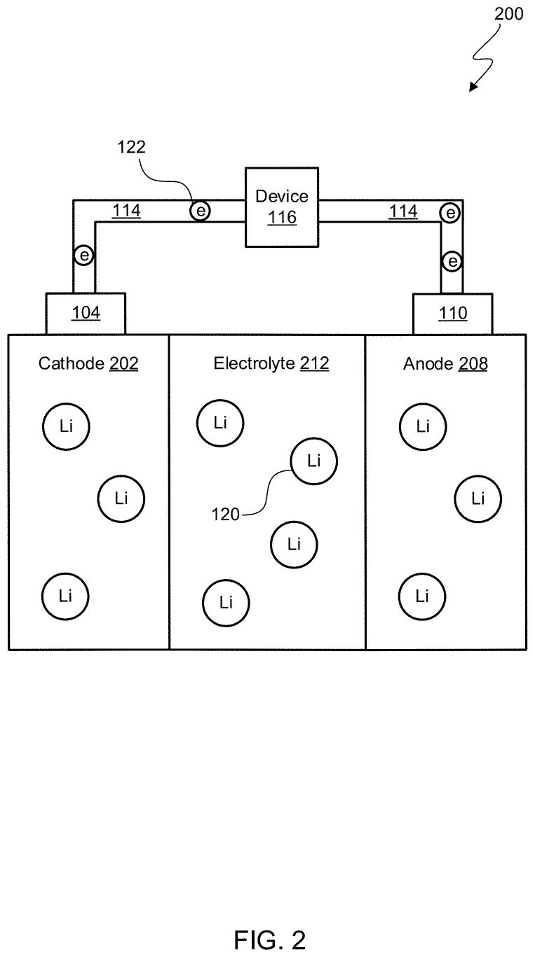

FIG. 2 depicts a solid-state battery 200 according to some embodiments provided herein. The solid-state battery 200 may be a lithium solid-state battery. Similar to conventional battery 100, solid-state battery 200 may include a solid-state battery cathode 202, a solid-state battery anode 208, and a solid-state electrolyte 212. However, unlike conventional battery 100, solid-state battery cathode 202, solid-state battery anode 208, and solid-state electrolyte 212 are all in a solid state (format). Solid-state battery 200 may produce electrical energy from electrochemical and/or chemical reactions. Additionally, solid-state battery 200 may be a rechargeable battery having reversible electrochemical capabilities allowing for repeated charging and discharging cycles with minimal impacts to the energy density or workable life of the solid-state battery 200.

The arrangement of solid-state battery 200 and respective components may vary depending on the configuration of solid-state battery 200. In some embodiments, the solid-state battery 200 may be cylindrical in shape having solid-state battery cathode 202 and solid-state battery anode 208 on a top surface or on opposite surfaces from one another. However, in other embodiments, solid-state battery 200 may be rectangular, square, button, in a pouch-like form, layered, or in a film state.

In embodiments, solid-state battery 200 may or be configured to power, completely or partially, device 116. Solid-state battery 200 may power device 116 via the same mechanism described with relation to FIG. 1. For example, solid-state battery 200 may power device 116 during a discharging process in which electrons 122 flow via electron path 114, while lithium ions 120 flow from solid-state battery anode 208, via solid-state electrolyte 212, to solid-state battery cathode 202. Similarly, during a charging process, solid-state battery 200 may be connected to an external power source which may apply an external voltage causing electrons 122 to flow, via electron path 114, from solid-state battery cathode 202 to solid-state battery anode 208. During a charging process, as the electrons 122 flow from the solid-state battery cathode 202 to the solid-state battery anode 208, via electron path 114, the lithium ions 120 may also flow from the solid-state battery cathode 202 to the solid-state battery anode 208, through solid-state electrolyte 212.

Solid-state battery cathode 202 may be a positive electrode comprised of different material types. The solid-state battery cathode 202 may include a plurality of cathode particles. The cathode particles may include an active material, such as lithium-cobalt oxide (LiCoO₂), lithium-manganese oxide (LiMn2O4), lithium iron phosphate (LiFePO₄), and/or another metal based alloy. In embodiments, solid-state battery cathode 202 may include layered oxides similar to LiCoO₂ but with added metals such as nickel, manganese and aluminum. For example, solid-state battery cathode 202 may include NCA (nickel cobalt aluminum) and NMC (nickel manganese cobalt). In some embodiments, the solid-state battery cathode 202 may include a solid electrolyte powder. In such embodiments, the plurality of cathode particles may be mixed with the solid electrolyte powder to form the solid-state battery cathode 202.

In some embodiments, solid-state battery cathode 202 may have a thickness from about 10 μm to about 500 μm. For example, the solid-state battery cathode 202 may have a thickness from about 25 μm to about 500 μm, from about 50 μm to about 500 μm, from about 75 μm to about 500 μm, from about 100 μm to about 500 μm, from about 125 μm to about 500 μm, from about 150 μm to about 500 μm, from about 175 μm to about 500 μm, from about 200 μm to about 500 μm, from about 225 μm to about 500 μm, from about 250 μm to about 500 μm, from about 275 μm to about 500 μm, from about 300 μm to about 500 μm, from about 325 μm to about 500 μm, from about 350 μm to about 500 μm, from about 375 μm to about 500 μm, from about 400 μm to about 500 μm, from about 425 μm to about 500 μm, from about 450 μm to about 500 μm, from about 475 μm to about 500 μm, from about 25 μm to about 475 μm, from about 50 μm to about 475 μm, from about 75 μm to about 475 μm, from about 100 μm to about 475 μm, from about 125 μm to about 475 μm, from about 150 μm to about 475 μm, from about 175 μm to about 475 μm, from about 200 μm to about 475 μm, from about 225 μm to about 475 μm, from about 250 μm to about 475 μm, from about 275 μm to about 475 μm, from about 300 μm to about 475 μm, from about 325 μm to about 475 μm, from about 350 μm to about 475 μm, from about 375 μm to about 475 μm, from about 400 μm to about 475 μm, from about 425 μm to about 475 μm, from about 450 μm to about 475 μm, from about 25 μm to about 450 μm, from about 50 μm to about 450 μm, from about 75 μm to about 450 μm, from about 100 μm to about 450 μm, from about 125 μm to about 450 μm, from about 150 μm to about 450 μm, from about 175 μm to about 450 μm, from about 200 μm to about 450 μm, from about 225 μm to about 450 μm, from about 250 μm to about 450 μm, from about 275 μm to about 450 μm, from about 300 μm to about 450 μm, from about 325 μm to about 450 μm, from about 350 μm to about 450 μm, from about 375 μm to about 450 μm, from about 400 μm to about 450 μm, from about 425 μm to about 450 μm, from about 25 μm to about 425 μm, from about 50 μm to about 425 μm, from about 75 μm to about 425 μm, from about 100 μm to about 425 μm, from about 125 μm to about 425 μm, from about 150 μm to about 425 μm, from about 175 μm to about 425 μm, from about 200 μm to about 425 μm, from about 225 μm to about 425 μm, from about 250 μm to about 425 μm, from about 275 μm to about 425 μm, from about 300 μm to about 425 μm, from about 325 μm to about 425 μm, from about 350 μm to about 425 μm, from about 375 μm to about 425 μm, from about 400 μm to about 425 μm, from about 25 μm to about 400 μm, from about 50 μm to about 400 μm, from about 75 μm to about 400 μm, from about 100 μm to about 400 μm, from about 125 μm to about 400 μm, from about 150 μm to about 400 μm, from about 175 μm to about 400 μm, from about 200 μm to about 400 μm, from about 225 μm to about 400 μm, from about 250 μm to about 400 μm, from about 275 μm to about 400 μm, from about 300 μm to about 400 μm, from about 325 μm to about 400 μm, from about 350 μm to about 400 μm, from about 375 μm to about 400 μm, from about 25 μm to about 375 μm, from about 50 μm to about 375 μm, from about 75 μm to about 375 μm, from about 100 μm to about 375 μm, from about 125 μm to about 375 μm, from about 150 μm to about 375 μm, from about 175 μm to about 375 μm, from about 200 μm to about 375 μm, from about 225 μm to about 375 μm, from about 250 μm to about 375 μm, from about 275 μm to about 375 μm, from about 300 μm to about 375 μm, from about 325 μm to about 375 μm, from about 350 μm to about 375 μm, from about 25 μm to about 350 μm, from about 50 μm to about 350 μm, from about 75 μm to about 350 μm, from about 100 μm to about 350 μm, from about 125 μm to about 350 μm, from about 150 μm to about 350 μm, from about 175 μm to about 350 μm, from about 200 μm to about 350 μm, from about 225 μm to about 350 μm, from about 250 μm to about 350 μm, from about 275 μm to about 350 μm, from about 300 μm to about 350 μm, from about 325 μm to about 350 μm, from about 25 μm to about 325 μm, from about 50 μm to about 325 μm, from about 75 μm to about 325 μm, from about 100 μm to about 325 μm, from about 125 μm to about 325 μm, from about 150 μm to about 325 μm, from about 175 μm to about 325 μm, from about 200 μm to about 325 nm, from about 225 nm to about 325 nm, from about 250 nm to about 325 nm, from about 275 nm to about 325 nm, from about 300 nm to about 325 nm, from about 25 nm to about 300 nm, from about 50 nm to about 300 nm, from about 75 nm to about 300 nm, from about 100 nm to about 300 nm, from about 125 nm to about 300 nm, from about 150 nm to about 300 nm, from about 175 nm to about 300 nm, from about 200 nm to about 300 nm, from about 225 nm to about 300 nm, from about 250 nm to about 300 nm, from about 275 nm to about 300 nm, from about 25 nm to about 275 nm, from about 50 nm to about 275 nm, from about 75 nm to about 275 nm, from about 100 nm to about 275 nm, from about 125 nm to about 275 nm, from about 150 nm to about 275 nm, from about 175 nm to about 275 nm, from about 200 nm to about 275 nm, from about 225 nm to about 275 nm, from about 250 nm to about 275 nm, from about 25 nm to about 250 nm, from about 50 nm to about 250 nm, from about 75 nm to about 250 nm, from about 100 nm to about 250 nm, from about 125 nm to about 250 nm, from about 150 nm to about 250 nm, from about 175 nm to about 250 nm, from about 200 nm to about 250 nm, from about 225 nm to about 250 nm, from about 25 nm to about 225 nm, from about 50 nm to about 225 nm, from about 75 nm to about 225 nm, from about 100 nm to about 225 nm, from about 125 nm to about 225 nm, from about 150 nm to about 225 nm, from about 175 nm to about 225 nm, from about 200 nm to about 225 nm, from about 25 nm to about 200 nm, from about 50 nm to about 200 nm, from about 75 nm to about 200 nm, from about 100 nm to about 200 nm, from about 125 nm to about 200 nm, from about 150 nm to about 200 nm, from about 175 nm to about 200 nm, from about 25 nm to about 175 nm, from about 50 nm to about 175 nm, from about 75 nm to about 175 nm, from about 100 nm to about 175 nm, from about 125 nm to about 175 nm, from about 150 nm to about 175 nm, from about 25 nm to about 150 nm, from about 50 nm to about 150 nm, from about 75 nm to about 150 nm, from about 100 nm to about 150 nm, from about 125 nm to about 150 nm, from about 25 nm to about 125 nm, from about 50 nm to about 125 nm, from about 75 nm to about 125 nm, from about 100 nm to about 125 nm, from about 25 nm to about 100 nm, from about 50 nm to about 100 nm, from about 75 nm to about 100 nm, from about 25 nm to about 75 nm, from about 50 nm to about 75 nm, or from about 25 nm to about 50 nm.

Solid-state battery anode 208 may be a negative electrode comprised of different material types. For example, solid-state battery anode 208 may include an anode material. The anode material may be compatible with solid-state lithium-ion battery chemistry, having porous and conductive properties. The anode material may be compatible with solid-state lithium-ion battery chemistry such that the anode material may support efficient and effective charging and discharging cycles of solid-state battery anode 208 without impacting the energy density or workable life of solid-state battery 200. In some embodiments, the anode material may be compatible with lithium-ion battery chemistry such that little to no damage may occur to the solid-state battery 200. For example, the anode material may allow solid-state battery 200 to maintain a consistent state of charge (or energy density) for 50 days with normal use.

The anode material may include one or more carbonaceous material, such as a graphite material (natural or synthetic), cokes, carbon and graphite fibers, or pyrolysis carbons. In some embodiments, the anode material include a graphite material comprising meso-carbon microbeads (MCMB). Optionally, solid-state battery anode 208 may include a silicon-containing material. In some cases, both the carbonaceous material, such as the graphite material, and the silicon-containing material may be present in solid-state battery anode 208. For example, the anode material may include both a silicon-containing material and MCMB. In embodiments, the silicon-containing material may include a silicon oxide (SiOₓ), silicene, silicon carbon composites, such as silicon carbide (SiC), or nanocrystalline Si. In embodiments, anode 108 may include additional materials. For example, solid-state battery anode 208 may include a solid electrolyte powder, a lithium metal (e.g., lithium titanate, lithium metal, or lithium-tin alloys), and/or a plurality of conductive fibers.

In some embodiments, solid-state battery anode 208 may have a thickness from about 10 μm to about 500 μm. For example, the solid-state battery anode 208 may have a thickness from about 25 μm to about 500 μm, from about 50 μm to about 500 μm, from about 75 μm to about 500 μm, from about 100 μm to about 500 μm, from about 125 μm to about 500 μm, from about 150 μm to about 500 μm, from about 175 μm to about 500 μm, from about 200 μm to about 500 μm, from about 225 μm to about 500 μm, from about 250 μm to about 500 μm, from about 275 μm to about 500 μm, from about 300 μm to about 500 μm, from about 325 μm to about 500 μm, from about 350 μm to about 500 μm, from about 375 μm to about 500 μm, from about 400 μm to about 500 μm, from about 425 μm to about 500 μm, from about 450 μm to about 500 μm, from about 475 μm to about 500 μm, from about 25 μm to about 475 μm, from about 50 μm to about 475 μm, from about 75 μm to about 475 μm, from about 100 μm to about 475 μm, from about 125 μm to about 475 μm, from about 150 μm to about 475 μm, from about 175 μm to about 475 μm, from about 200 μm to about 475 μm, from about 225 μm to about 475 μm, from about 250 μm to about 475 μm, from about 275 μm to about 475 μm, from about 300 μm to about 475 μm, from about 325 μm to about 475 μm, from about 350 μm to about 475 μm, from about 375 μm to about 475 μm, from about 400 μm to about 475 μm, from about 425 μm to about 475 μm, from about 450 μm to about 475 μm, from about 25 μm to about 450 μm, from about 50 μm to about 450 μm, from about 75 μm to about 450 μm, from about 100 μm to about 450 μm, from about 125 μm to about 450 μm, from about 150 μm to about 450 μm, from about 175 μm to about 450 μm, from about 200 μm to about 450 μm, from about 225 μm to about 450 μm, from about 250 μm to about 450 μm, from about 275 μm to about 450 μm, from about 300 μm to about 450 μm, from about 325 μm to about 450 μm, from about 350 μm to about 450 μm, from about 375 μm to about 450 μm, from about 400 μm to about 450 μm, from about 425 μm to about 450 μm, from about 25 μm to about 425 μm, from about 50 μm to about 425 μm, from about 75 μm to about 425 μm, from about 100 μm to about 425 μm, from about 125 μm to about 425 μm, from about 150 μm to about 425 μm, from about 175 μm to about 425 μm, from about 200 μm to about 425 μm, from about 225 μm to about 425 μm, from about 250 μm to about 425 μm, from about 275 μm to about 425 μm, from about 300 μm to about 425 μm, from about 325 μm to about 425 μm, from about 350 μm to about 425 μm, from about 375 μm to about 425 μm, from about 400 μm to about 425 μm, from about 25 μm to about 400 μm, from about 50 μm to about 400 μm, from about 75 μm to about 400 μm, from about 100 μm to about 400 μm, from about 125 μm to about 400 μm, from about 150 μm to about 400 μm, from about 175 μm to about 400 μm, from about 200 μm to about 400 μm, from about 225 μm to about 400 μm, from about 250 μm to about 400 μm, from about 275 μm to about 400 μm, from about 300 μm to about 400 μm, from about 325 μm to about 400 μm, from about 350 μm to about 400 μm, from about 375 μm to about 400 μm, from about 25 μm to about 375 μm, from about 50 μm to about 375 μm, from about 75 μm to about 375 μm, from about 100 μm to about 375 μm, from about 125 μm to about 375 μm, from about 150 μm to about 375 μm, from about 175 μm to about 375 μm, from about 200 μm to about 375 μm, from about 225 μm to about 375 μm, from about 250 μm to about 375 μm, from about 275 μm to about 375 μm, from about 300 μm to about 375 μm, from about 325 μm to about 375 μm, from about 350 μm to about 375 μm, from about 25 μm to about 350 μm, from about 50 μm to about 350 μm, from about 75 μm to about 350 μm, from about 100 μm to about 350 μm, from about 125 μm to about 350 μm, from about 150 μm to about 350 μm, from about 175 μm to about 350 μm, from about 200 μm to about 350 μm, from about 225 μm to about 350 μm, from about 250 μm to about 350 μm, from about 275 μm to about 350 μm, from about 300 μm to about 350 μm, from about 325 μm to about 350 μm, from about 25 μm to about 325 μm, from about 50 μm to about 325 μm, from about 75 μm to about 325 μm, from about 100 μm to about 325 μm, from about 125 μm to about 325 μm, from about 150 μm to about 325 μm, from about 175 μm to about 325 μm, from about 200 μm to about 325 μm, from about 225 μm to about 325 μm, from about 250 μm to about 325 μm, from about 275 μm to about 325 μm, from about 300 μm to about 325 μm, from about 25 μm to about 300 μm, from about 50 μm to about 300 μm, from about 75 μm to about 300 μm, from about 100 μm to about 300 μm, from about 125 μm to about 300 μm, from about 150 μm to about 300 μm, from about 175 μm to about 300 μm, from about 200 μm to about 300 μm, from about 225 μm to about 300 μm, from about 250 μm to about 300 μm, from about 275 μm to about 300 μm, from about 25 μm to about 275 μm, from about 50 μm to about 275 μm, from about 75 μm to about 275 μm, from about 100 μm to about 275 μm, from about 125 μm to about 275 μm, from about 150 μm to about 275 μm, from about 175 μm to about 275 μm, from about 200 μm to about 275 μm, from about 225 μm to about 275 μm, from about 250 μm to about 275 μm, from about 25 μm to about 250 μm, from about 50 μm to about 250 μm, from about 75 μm to about 250 μm, from about 100 μm to about 250 μm, from about 125 μm to about 250 μm, from about 150 μm to about 250 μm, from about 175 μm to about 250 μm, from about 200 μm to about 250 μm, from about 225 μm to about 250 μm, from about 25 μm to about 225 μm, from about 50 μm to about 225 μm, from about 75 μm to about 225 μm, from about 100 μm to about 225 μm, from about 125 μm to about 225 μm, from about 150 μm to about 225 μm, from about 175 μm to about 225 μm, from about 200 μm to about 225 μm, from about 25 μm to about 200 μm, from about 50 μm to about 200 μm, from about 75 μm to about 200 μm, from about 100 μm to about 200 μm, from about 125 μm to about 200 μm, from about 150 μm to about 200 μm, from about 175 μm to about 200 μm, from about 25 μm to about 175 μm, from about 50 μm to about 175 μm, from about 75 μm to about 175 μm, from about 100 μm to about 175 μm, from about 125 μm to about 175 μm, from about 150 μm to about 175 μm, from about 25 μm to about 150 μm, from about 50 μm to about 150 μm, from about 75 μm to about 150 μm, from about 100 μm to about 150 μm, from about 125 μm to about 150 μm, from about 25 μm to about 125 μm, from about 50 μm to about 125 μm, from about 75 μm to about 125 μm, from about 100 μm to about 125 μm, from about 25 μm to about 100 μm, from about 50 μm to about 100 μm, from about 75 μm to about 100 μm, from about 25 μm to about 75 μm, from about 50 μm to about 75 μm, or from about 25 μm to about 50 μm.

Solid-state electrolyte 212 may separate solid-state battery cathode 202 and solid-state battery anode 208 while allowing lithium ions 120 to flow between solid-state battery cathode 202 and solid-state battery anode 208. In such embodiments, solid-state electrolyte 212 may be a solid electrolyte separator positioned between solid-state battery cathode 202 and solid-state battery anode 208. Solid-state electrolyte 212 may inhibit electrons 122 from transferring or moving between solid-state battery anode 208 and solid-state battery cathode 202, and force or induce electrons 122 to travel along electron path 114, as described above.

In some embodiments, solid-state electrolyte 212 may have a thickness from about 10 μm to about 100 μm. For example, the solid-state electrolyte 212 may have a thickness from about 20 μm to about 100 μm, from about 30 μm to about 100 μm, from about 35 μm to about 100 μm, from about 40 μm to about 100 μm, from about 45 μm to about 100 μm, from about 50 μm to about 100 μm, from about 55 μm to about 100 μm, from about 60 μm to about 100 μm, from about 65 μm to about 100 μm, from about 70 μm to about 100 μm, from about 75 μm to about 100 μm, from about 80 μm to about 100 μm, from about 85 μm to about 100 μm, from about 90 μm to about 100 μm, from about 95 μm to about 100 μm, from about 25 μm to about 95 μm, from about 30 μm to about 95 μm, from about 35 μm to about 95 μm, from about 40 μm to about 95 μm, from about 45 μm to about 95 μm, from about 50 μm to about 95 μm, from about 55 μm to about 95 μm, from about 60 μm to about 95 μm, from about 65 μm to about 95 μm, from about 70 μm to about 95 μm, from about 75 μm to about 95 μm, from about 80 μm to about 95 μm, from about 85 μm to about 95 μm, from about 90 μm to about 95 μm, from about 25 μm to about 90 μm, from about 30 μm to about 90 μm, from about 35 μm to about 90 μm, from about 40 μm to about 90 μm, from about 45 μm to about 90 μm, from about 50 μm to about 90 μm, from about 55 μm to about 90 μm, from about 60 μm to about 90 μm, from about 65 μm to about 90 μm, from about 70 μm to about 90 μm, from about 75 μm to about 90 μm, from about 80 μm to about 90 μm, from about 85 μm to about 90 μm, from about 25 μm to about 85 μm, from about 30 μm to about 85 μm, from about 35 μm to about 85 μm, from about 40 nm to about 85 nm, from about 45 nm to about 85 nm, from about 50 nm to about 85 nm, from about 55 nm to about 85 nm, from about 60 nm to about 85 nm, from about 65 nm to about 85 nm, from about 70 nm to about 85 nm, from about 75 nm to about 85 nm, from about 80 nm to about 85 nm, from about 25 nm to about 80 nm, from about 30 nm to about 80 nm, from about 35 nm to about 80 nm, from about 40 nm to about 80 nm, from about 45 nm to about 80 nm, from about 50 nm to about 80 nm, from about 55 nm to about 80 nm, from about 60 nm to about 80 nm, from about 65 nm to about 80 nm, from about 70 nm to about 80 nm, from about 75 nm to about 80 nm, from about 25 nm to about 75 nm, from about 30 nm to about 75 nm, from about 35 nm to about 75 nm, from about 40 nm to about 75 nm, from about 45 nm to about 75 nm, from about 50 nm to about 75 nm, from about 55 nm to about 75 μm, from about 60 nm to about 75 nm, from about 65 nm to about 75 nm, from about 70 nm to about 75 nm, from about 25 nm to about 70 nm, from about 30 nm to about 70 nm, from about 35 nm to about 70 nm, from about 40 nm to about 70 nm, from about 45 nm to about 70 nm, from about 50 nm to about 70 nm, from about 55 nm to about 70 nm, from about 60 nm to about 70 nm, from about 65 nm to about 70 nm, from about 25 nm to about 65 nm, from about 30 nm to about 65 nm, from about 35 nm to about 65 nm, from about 40 nm to about 65 nm, from about 45 nm to about 65 nm, from about 50 nm to about 65 nm, from about 55 nm to about 65 nm, from about 60 nm to about 65 nm, from about 25 nm to about 60 nm, from about 30 nm to about 60 nm, from about 35 nm to about 60 nm, from about 40 nm to about 60 nm, from about 45 nm to about 60 nm, from about 50 nm to about 60 nm, from about 55 nm to about 60 nm, from about 25 nm to about 55 nm, from about 30 nm to about 55 nm, from about 35 nm to about 55 nm, from about 40 nm to about 55 nm, from about 45 nm to about 55 nm, from about 50 nm to about 55 nm, from about 25 nm to about 50 nm, from about 30 nm to about 50 nm, from about 35 nm to about 50 nm, from about 40 nm to about 50 nm, from about 45 nm to about 50 nm, from about 25 nm to about 45 nm, from about 30 nm to about 45 nm, from about 35 nm to about 45 nm, from about 40 nm to about 45 nm, from about 25 nm to about 40 nm, from about 30 nm to about 40 nm, from about 35 nm to about 40 nm, from about 25 nm to about 35 nm, from about 30 nm to about 35 nm, or from about 25 nm to about 30 nm.

As the name indicates, solid-state electrolyte 212 may be a solid electrolyte. Solid-state electrolyte 212 may include a polymer solid-state electrolyte, a solid electrolyte powder, such as an inorganic solid-state electrolyte, or a sulfur based electrolyte. Exemplary polymer solid-state electrolytes may include polyethylene oxide (POE), which may contain a lithium salt, such as lithium hexafluorophosphate (LiPF₆), lithium bis(trifluoromethanesulfonypimide (LiTFSI), lithium bis(fluorosulfonyl)imide (LiFSI), lithium bis(oxalate)borate (LiBOB), lithium tetrafluoroborate (LiBF₄), and lithium perchlorate (LiClO₄). Exemplary inorganic solid-state electrolytes may include an oxide such as lithium aluminum titanium phosphate (LATP; Li₁₊ₓAl_{y}Ti_{2-y}PO₄.), for example Li_{1.3}Al_{0.3}Ti_{1.7}(PO₄)₃, a lithium aluminum germanium phosphate (LAGP), for example Li_{1.5}Al_{0.5}Ge_{1.5}P₃O₁₂, Li_{1.3}Al_{0.3}Ge_{1.7}(PO₄)₃, or Li_{1.5}Al_{1.5}Ge_{1.5}(PO₄)₃, a lithium phosphorous oxy-nitride (LiPON), for example Li_{2.9}PO_{3.3}N_{0.4}, or a lithium lanthanum zirconate oxide (LLZO), for example Li₇La₃Zr₂O₁₂. Inorganic solid-state electrolytes may also include complex hydrides, such as iodide substitution in lithium borohydride (LiBH₄—LiI) or lithium nitride (Li₃N). In embodiments, solid-state electrolyte 212 may include a sulfur-based solid electrolyte. Exemplary sulfur-based solid electrolytes may include a lithium germanium phosphorous sulfide (LGPS), such as Li₁₀GeP₂S₁₂ or a lithium phosphorus sulfide (LPS), such as Li₂S—P₂S₅.

As noted above, solid electrolytes, such as solid-state electrolyte 212, may improve battery safety over conventional lithium-ion batteries, such as conventional battery 100. However, the physical limitations of solid electrolytes may make them inherently less conductive than their liquid counterparts due to the slowed ion diffusion through the solid medium. High interfacial resistance between the electrodes and electrolyte surfaces may make ion diffusion difficult in solid-state batteries, such as solid-state battery 200. The interfacial resistance may be due to poor contact between the solid surfaces (of the electrodes and electrolyte) and/or the poor penetration of electrolyte into the porous anode. With a liquid electrolyte, like electrolyte 112, the electrolyte is free to saturate the electrode structure. This allows for utilization of lithium ions 120 which have intercalated deep within the electrode structure. However, when a solid electrolyte is used, the electrode-electrolyte interface may be greatly reduced and the number of usable lithium ions available to transfer charge may be significantly restricted. Typically, the way to overcome this challenge is to introduce a small amount of liquid electrolyte at the electrode-electrolyte interface to reduce that interfacial resistance. This, however, defeats the purpose of using a solid electrolyte to improve battery safety.

The solid-state battery anode 208, as provided herein, may increase interfacial contact between the electrode (solid-state battery anode 208) and solid-state electrolyte 212 and reduce interfacial resistivity. As explained in relation to the following figures, the solid-state battery anode 208 may reduce interfacial resistivity by increasing interfacial contact between the solid-state battery anode 208 and solid-state electrolyte 212. Additionally, the solid-state battery anode 208 may reduce or inhibit electrolyte decomposition and thereby allow for interfacial contact between the solid-state battery anode 208 and solid-state electrolyte 212 to be maintained over extended usage. Moreover, the solid-state battery anode 208 may increase utilization of deeply intercalated lithium ions within the solid-state battery anode 208 structure by creating a conductive network. The solid-state battery anode 208, and corresponding solid-state battery 200 including the solid-state battery anode 208 may have improved energy density, energy capacity, and overall cycling capabilities.

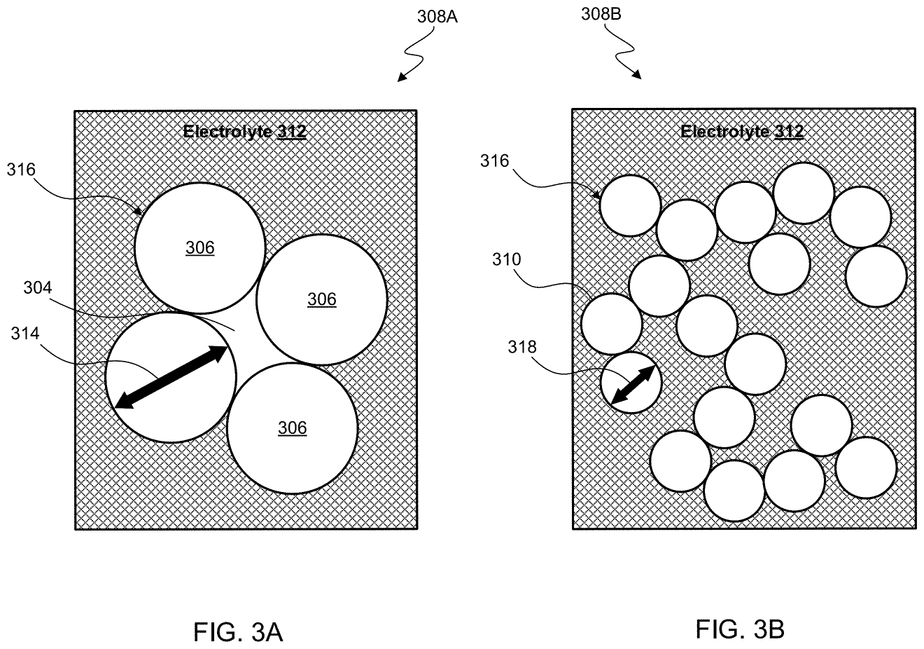

FIG. 3A illustrates a solid-state battery anode 308 A. Solid-state battery anode 308 A may include an anode material. The anode material may include solid-state electrolyte 312 and a plurality of graphite particles 306. In some embodiments, the plurality of graphite particles 306 may include MCMB. Solid-state electrolyte 312 may be a solid-state electrolyte, such as solid-state electrolyte 212. Solid-state electrolyte 312 may contact one or more graphite particles 306 at an interface 316. Interface 316 may exist where the surface of solid-state electrolyte 312 contacts the surface of graphite particle 306. While interface 316 may be illustrated as continuous contact between the solid surfaces of solid-state electrolyte 312 and one or more of the graphite particles 306, the interface 316 may include inconsistent contact between the surfaces due to variation in surface features. However, interface 316 may preclude voids or vacancies between the surfaces, thereby allowing for increased conductivity and lithium ion 120 transmission between the two materials.

In conventional lithium-ion batteries, such as conventional battery 100, the electrolyte 112 may be a liquid. However, in solid-state batteries, such as solid-state battery 200, the solid-state electrolyte 212, or in this case solid-state electrolyte 312, is solid. Without liquid fluidity, achieving and sustaining intimate contact between solid-state electrolyte 312 and solid-state anode material may be challenging. The periodic electrode expanding and shrinking during charging and discharging cycles further deteriorates the mechanical particle-to-particle contact. As a consequence, high polarization, and low utilization of active materials may result within solid-state battery anode. In other words, reduced interfacial contact may result in increased resistivity within the solid-state battery anode 308 A, and an overall reduction in anode capacity.

FIG. 3A may illustrate one of the causes of reduced interfacial contact between solid-state electrolytes and solid-state battery anodes. Large graphite particles, such as graphite particles 306, may cause reduced or insufficient interfacial contact. Graphite particles 306 may be large particles. In embodiments, the plurality of graphite particles 306 may be characterized by a spherical shape. Characterization as spherical in shape may mean that while each of the graphite particles 306 are not true spheres, the general shape of the graphite particle 306 may have a diameter or allow for the graphite particle 306 to be measured by a diameter. The size of a graphite particle 306 may be characterized by a diameter 314 of the graphite particles 306. The diameter 314 of the plurality of particles 306 may correspond to a D-value for the plurality of graphite particles 306. D-values are a commonly used method of describing a particle size distribution. A D-value can be thought of as a “mass division diameter”. It is the diameter which, when all particles in a sample are arranged in order of ascending mass, divides the sample's mass into specified percentages. The percentage mass below the diameter of interest is the number expressed after the “D”. For example the D10 diameter is the diameter at which 10% of a sample's mass is comprised of smaller particles, and the D50 is the diameter at which 50% of a sample's mass is comprised of smaller particles. The D50 is also known as the “mass median diameter” as it divides the sample equally by mass. The D10, D50 and D90 are commonly used to represent the midpoint and range of the particle sizes of a given sample.

In embodiments, the diameter 314 of the plurality of graphite particles 306 may be a D50 diameter of about or greater than 25 μm. For example, diameter 314 may be a D50 diameter of about 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, 300 μm, 350 μm, 400 μm, 450 μm, 500 μm, 550 μm, 600 μm, 650 μm, 700 μm, 750 μm, 800 μm, 850 μm, 900 μm, 950 μm, or 1 mm. In some embodiments, diameter 314 may correspond to a D10 diameter, D25 diameter, D30 diameter, D40 diameter, D45 diameter, D55 diameter, D60 diameter, D70 diameter, D75 diameter, D80 diameter, D90 diameter, D95 diameter, D99 diameter, or a D100 diameter in which all the plurality of graphite particles 306 are smaller than the D100 value within a sample.

Large particles, like the plurality of graphite particles 306, may form void 304. Void 304 may be a large volume of closed vacancy formed by the plurality of particles 306. Void 304 may hinder direct contact, or formation of interface 316, between the graphite particles 306 and the solid-state electrolyte 312. As described above, poor or insufficient interfacial contact (i.e., lack or reduced of formation of interface 316) may cause high interfacial resistance, within the anode 308 A. Interfacial resistance is the ease at which a lithium ion can move between the electrode and the electrolyte, and vice versa. The higher the interfacial resistivity, the more difficult it is for the lithium ion 120 to move between the electrode and the electrolyte. As such, large particles, like graphite particles 306 may reduce or impede lithium ion 120 intercalation and deintercalation into and out of anode 308A due to increased interfacial resistivity caused by void 304.

FIG. 3B illustrates solid-state battery anode 308B including a plurality of graphite particles 310 having reduced size. Solid-state battery anode 308B may be the same as solid-state battery anode 308A and include the plurality of graphite particles 310 and solid-state electrolyte 312. The graphite particles 310 may be the same as graphite particles 306 except for having a smaller size. For example, graphite particles 310 may include MCMB.

The plurality of graphite particles 310 may have a reduced size. In embodiments, the plurality of graphite particles 310 may be characterized as spherical in shape. As described above with relation to graphite particles 306, characterization as spherical may mean that the graphite particles 310 have a diameter or may be measured based on diameter, regardless of whether the graphite particles 310 are actually spherical. The size of graphite particles 310 may be characterized by a diameter 318. The diameter 318 of the plurality of particles 310 may correspond to a D-value for the plurality of graphite particles 310.

In embodiments, the diameter 318 of the plurality of graphite particles 310 may be a D50 diameter of about or less than 20 μm. For example, diameter 318 may be a D50 diameter from about 0.5 μm to about 20 μm, from about 0.75 μm to about 20 μm, from about 1 μm to about 20 μm, from about 2 μm to about 20 μm, from about 3 μm to about 20 μm, from about 4 μm to about 20 μm, from about 5 μm to about 20 μm, from about 6 μm to about 20 μm, from about 7 μm to about 20 μm, from about 8 μm to about 20 μm, from about 9 μm to about 20 μm, from about 10 μm to about 20 μm, from about 11 μm to about 20 μm, from about 12 μm to about 20 μm, from about 13 μm to about 20 μm, from about 14 μm to about 20 μm, from about 15 μm to about 20 μm, from about 16 μm to about 20 μm, from about 17 μm to about 20 μm, from about 18 μm to about 20 μm, from about 19 μm to about 20 μm, from about 0.5 μm to about 19 μm, from about 0.75 μm to about 19 μm, from about 1 μm to about 19 μm, from about 2 μm to about 19 μm, from about 3 μm to about 19 μm, from about 4 μm to about 19 μm, from about 5 μm to about 19 μm, from about 6 μm to about 19 μm, from about 7 μm to about 19 μm, from about 8 μm to about 19 μm, from about 9 μm to about 19 μm, from about 10 μm to about 19 μm, from about 11 μm to about 19 μm, from about 12 μm to about 19 μm, from about 13 μm to about 19 μm, from about 14 μm to about 19 μm, from about 15 μm to about 19 μm, from about 16 μm to about 19 μm, from about 17 μm to about 19 μm, from about 18 μm to about 19 μm, from about 0.5 μm to about 18 μm, from about 0.75 μm to about 18 μm, from about 1 μm to about 18 μm, from about 2 μm to about 18 μm, from about 3 μm to about 18 μm, from about 4 μm to about 18 μm, from about 5 μm to about 18 μm, from about 6 μm to about 18 μm, from about 7 μm to about 18 μm, from about 8 μm to about 18 μm, from about 9 μm to about 18 μm, from about 10 μm to about 18 μm, from about 11 μm to about 18 μm, from about 12 μm to about 18 μm, from about 13 μm to about 18 μm, from about 14 μm to about 18 μm, from about 15 μm to about 18 μm, from about 16 μm to about 18 μm, from about 17 μm to about 18 μm, from about 0.5 μm to about 17 μm, from about 0.75 μm to about 17 μm, from about 1 μm to about 17 μm, from about 2 μm to about 17 μm, from about 3 μm to about 17 μm, from about 4 μm to about 17 μm, from about 5 μm to about 17 μm, from about 6 μm to about 17 μm, from about 7 μm to about 17 μm, from about 8 μm to about 17 μm, from about 9 μm to about 17 μm, from about 10 μm to about 17 μm, from about 11 μm to about 17 μm, from about 12 μm to about 17 μm, from about 13 μm to about 17 μm, from about 14 μm to about 17 μm, from about 15 μm to about 17 μm, from about 16 μm to about 17 μm, from about 0.5 μm to about 16 μm, from about 0.75 μm to about 16 μm, from about 1 μm to about 16 μm, from about 2 μm to about 16 μm, from about 3 μm to about 16 μm, from about 4 μm to about 16 μm, from about 5 μm to about 16 μm, from about 6 μm to about 16 μm, from about 7 μm to about 16 μm, from about 8 μm to about 16 μm, from about 9 μm to about 16 μm, from about 10 μm to about 16 μm, from about 11 μm to about 16 μm, from about 12 μm to about 16 μm, from about 13 μm to about 16 μm, from about 14 μm to about 16 μm, from about 15 μm to about 16 μm, from about 0.5 μm to about 15 μm, from about 0.75 μm to about 15 μm, from about 1 μm to about 15 μm, from about 2 μm to about 15 μm, from about 3 μm to about 15 μm, from about 4 μm to about 15 μm, from about 5 μm to about 15 μm, from about 6 μm to about 15 μm, from about 7 μm to about 15 μm, from about 8 μm to about 15 μm, from about 9 μm to about 15 μm, from about 10 μm to about 15 μm, from about 11 μm to about 15 μm, from about 12 μm to about 15 μm, from about 13 μm to about 15 μm, from about 14 μm to about 15 μm, from about 0.5 μm to about 14 μm, from about 0.75 μm to about 14 μm, from about 1 μm to about 14 μm, from about 2 μm to about 14 μm, from about 3 μm to about 14 μm, from about 4 μm to about 14 μm, from about 5 μm to about 14 μm, from about 6 μm to about 14 μm, from about 7 μm to about 14 μm, from about 8 μm to about 14 μm, from about 9 μm to about 14 μm, from about 10 μm to about 14 μm, from about 11 μm to about 14 μm, from about 12 μm to about 14 μm, from about 13 μm to about 14 μm, from about 0.5 μm to about 13 μm, from about 0.75 μm to about 13 μm, from about 1 μm to about 13 μm, from about 2 μm to about 13 μm, from about 3 μm to about 13 μm, from about 4 μm to about 13 μm, from about 5 μm to about 13 μm, from about 6 μm to about 13 μm, from about 7 μm to about 13 μm, from about 8 μm to about 13 μm, from about 9 μm to about 13 μm, from about 10 μm to about 13 μm, from about 11 μm to about 13 μm, from about 12 μm to about 13 μm, from about 0.5 μm to about 12 μm, from about 0.75 μm to about 12 μm, from about 1 μm to about 12 μm, from about 2 μm to about 12 μm, from about 3 μm to about 12 μm, from about 4 μm to about 12 μm, from about 5 μm to about 12 μm, from about 6 μm to about 12 μm, from about 7 μm to about 12 μm, from about 8 μm to about 12 μm, from about 9 μm to about 12 μm, from about 10 μm to about 12 μm, from about 11 μm to about 12 μm, from about 0.5 μm to about 11 μm, from about 0.75 μm to about 11 μm, from about 1 μm to about 11 μm, from about 2 μm to about 11 μm, from about 3 μm to about 11 μm, from about 4 μm to about 11 μm, from about 5 μm to about 11 μm, from about 6 μm to about 11 μm, from about 7 μm to about 11 μm, from about 8 μm to about 11 μm, from about 9 μm to about 11 μm, from about 10 μm to about 11 μm, from about 0.5 μm to about 10 μm, from about 0.75 μm to about 10 μm, from about 1 μm to about 10 μm, from about 2 μm to about 10 μm, from about 3 μm to about 10 μm, from about 4 μm to about 10 μm, from about 5 μm to about 10 μm, from about 6 μm to about 10 μm, from about 7 μm to about 10 μm, from about 8 μm to about 10 μm, from about 9 μm to about 10 μm, from about 0.5 μm to about 9 μm, from about 0.75 μm to about 9 μm, from about 1 μm to about 9 μm, from about 2 μm to about 9 μm, from about 3 μm to about 9 μm, from about 4 μm to about 9 μm, from about 5 μm to about 9 μm, from about 6 μm to about 9 μm, from about 7 μm to about 9 μm, from about 8 μm to about 9 μm, from about 0.5 μm to about 8 μm, from about 0.75 μm to about 8 μm, from about 1 μm to about 8 μm, from about 2 μm to about 8 μm, from about 3 μm to about 8 μm, from about 4 μm to about 8 μm, from about 5 μm to about 8 μm, from about 6 μm to about 8 μm, from about 7 μm to about 8 μm, from about 0.5 μm to about 7 μm, from about 0.75 μm to about 7 μm, from about 1 μm to about 7 μm, from about 2 μm to about 7 μm, from about 3 μm to about 7 μm, from about 4 μm to about 7 μm, from about 5 μm to about 7 μm, from about 6 μm to about 7 μm, from about 0.5 μm to about 6 μm, from about 0.75 μm to about 6 μm, from about 1 μm to about 6 μm, from about 2 μm to about 6 μm, from about 3 μm to about 6 μm, from about 4 μm to about 6 μm, from about 5 μm to about 6 μm, from about 0.5 μm to about 5 μm, from about 0.75 μm to about 5 μm, from about 1 μm to about 5 μm, from about 2 μm to about 5 μm, from about 3 μm to about 5 μm, from about 4 μm to about 5 μm, from about 0.5 μm to about 4 μm, from about 0.75 μm to about 4 μm, from about 1 μm to about 4 μm, from about 2 μm to about 4 μm, from about 3 μm to about 4 μm, from about 0.5 μm to about 3 μm, from about 0.75 μm to about 3 μm, from about 1 μm to about 3 μm, from about 2 μm to about 3 μm, from about 0.5 μm to about 2 μm, from about 0.75 μm to about 2 μm, from about 1 μm to about 2 μm, from about 0.5 μm to about 1 μm, from about 0.75 μm to about 1 μm, or from about 0.5 μm to about 0.75 μm.

In some embodiments, diameter 318 may correspond to a D10 diameter, D25 diameter, D30 diameter, D40 diameter, D45 diameter, D55 diameter, D60 diameter, D70 diameter, D75 diameter, D80 diameter, D90 diameter, D95 diameter, D99 diameter, or a D100 diameter in which all the plurality of graphite particles 310 are smaller than the D100 value within a sample.

Small particles, like the plurality of graphite particles 310, may inhibit or reduce formation of voids or vacancies, such as void 304. Because smaller particles have reduced volume, formation of voids or vacancies are less likely to occur. Moreover, a reduced size may increase the surface area of the plurality of graphite particles 310. The more surface area the plurality of graphite particles 310 have the larger the interface 316 may be between the graphite particles 310 and the solid-state electrolyte 312. Increasing the interface 316 between the solid surfaces of the graphite particles 310 and the solid-state electrolyte 312 may reduce interfacial resistivity within anode 308B and thereby allow for increased lithium ion 120 diffusion into and out of the solid-state battery anode 308B.

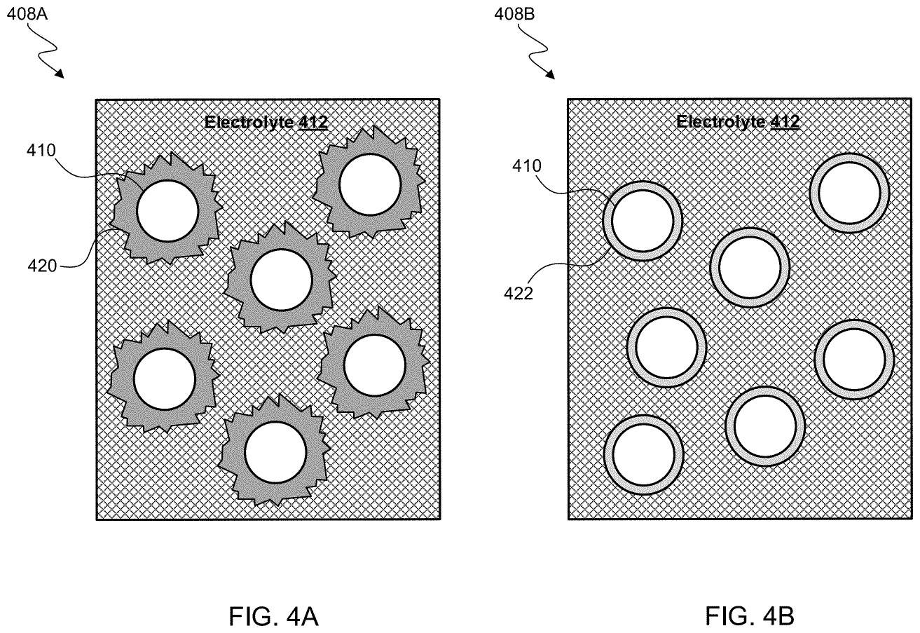

Another challenge that solid-state batteries face is interfacial reactivity between the solid-state battery anode and the solid-state electrolyte. FIG. 4A illustrates a solid-state battery anode 408A undergoing interfacial reactions. Solid-state battery anode 408A may include an anode material comprising a plurality of graphite particles 410 and solid-state electrolyte 412. The graphite particles 410 may be the same as graphite particles 310. Solid-state electrolyte 412 may be a solid electrolyte, such as solid-state electrolyte 312 or 212.

There are many chemical, electrochemical, and mechanical stability issues at the interfaces between graphite particles 410 and solid-state electrolyte 412. In particular, redox instability of the solid-state electrolyte 412 within the solid-state battery anode 408A may cause for unwanted interfacial reactions 420 to occur at the interface. These interfacial reactions 420, which are sometimes referred to as side reactions, may result in an increase in interfacial resistance and may greatly degrade battery performance during repeated cycling. Because these interfacial reactions 420, for the most part, are irreversible reactions, they may be highly undesirable.

The origin of interfacial reactions 420 may be the high thermodynamic reactivity of the anode material, such as the graphite particles 410, with the solid-state electrolyte 412. Interface instability may derive from an abrupt electrochemical potential change at the electrode-electrolyte interface. During charging, lithium ions 120 are extracted from the cathode and migrate to anode via the solid electrolyte, while electrons 122 transfer from the cathode to anode through an external circuit, such as electron path 114. In this process, oxidation and reduction reactions take place at the cathode and anode sides, respectively. During discharging, the lithium ions 120 and electrons 122 migrate toward the reverse direction, accompanied with cathode reduction, and anode oxidation. During the charging and discharging cycles, the following reaction steps may occur at electrode-electrolyte interface within solid-state batteries: (i) lithium ions 120 may diffuse into the electrolyte, (ii) lithium ions 120 may hop into the first lattice site of the electrode while a oxidation/reduction reaction occurs at the same time (i.e., the charge transfer process), (iii) lithium ions 120 may diffuse into the electrode, and (iv) a surface reaction may occur.

During the above reaction steps, an abrupt change of electrical potential can occur across the electrode-electrolyte interface due to the lithium ion 120 movement. This abrupt change in electrical potential may cause interfacial reactions 420 to occur or accelerate. For example, the electric potential drop caused by polarization between the anode 408A and solid-state electrolyte 412 may cause or accelerate interfacial reactions 420. Interfacial reactions 420 may accelerate due to the specific local electric potential.

In some cases, interfacial degradation may occur as a result of the interfacial reactions 420. Interfacial degradation may include electrolyte decomposition and/or formation of an intermediate transition layer or solid-electrolyte interphase (SEI) at the interface. Interfacial degradation may cause for low initial coulombic efficiency and reduce the overall working lifespan of the solid-state battery.

Interfacial degradation may also impact formation and maintenance of the electrode-electrolyte interface 316. As the electrolyte decomposes or as a solid-electrolyte interphase forms at the interface 316, interfacial contact between the graphite particles 410 and solid-state electrolyte 412 may become impacted or even impeded. Impedance of interfacial contact between the graphite particles 410 and solid-state electrolyte 412 may create large polarization, in addition to increase interfacial resistivity. And as described above, generation of large polarization may act to further accelerate interfacial reactions 420, resulting in further interfacial degradation. Hence, interfacial reactions 420 may form a harmful cycle that may eventually lead to battery failure.

Apart from solid electrolyte modification, surface modification of the anode material may mitigate interfacial degradation by preventing interfacial reactions 420. As illustrated by FIG. 4B, formation of a coating 422 on the plurality of graphite particles 410 may reduce or impede interfacial reactions 420 from occurring. Solid-state battery anode 408B may be the same as solid-state battery anode 408A except that the plurality of graphite particles 410 have a coating 422.

Coating 422 may be a solid-state interfacial coating. Coating 422 may be different than coatings used in conventional lithium-ion batteries, such as conventional battery 100 because of the different properties present at solid-state interfaces, such as interface 316. In some embodiments, coating 422 may include carbon-containing material. For example, in some embodiments coating 422 may include graphene. In some cases, coating 422 may include a low-crystallinity carbon. Crystallinity as used herein refers to the regularity of a solid's structure. If the atoms that make up the solid material are periodic and well-ordered, crystallinity is high. If the atoms are irregular and haphazard, crystallinity is low. Low crystallinity may also be referred to as amorphous. The more amorphous a material is, the less crystalline it is, and conversely, the more crystalline the material, the less amorphous the material is.

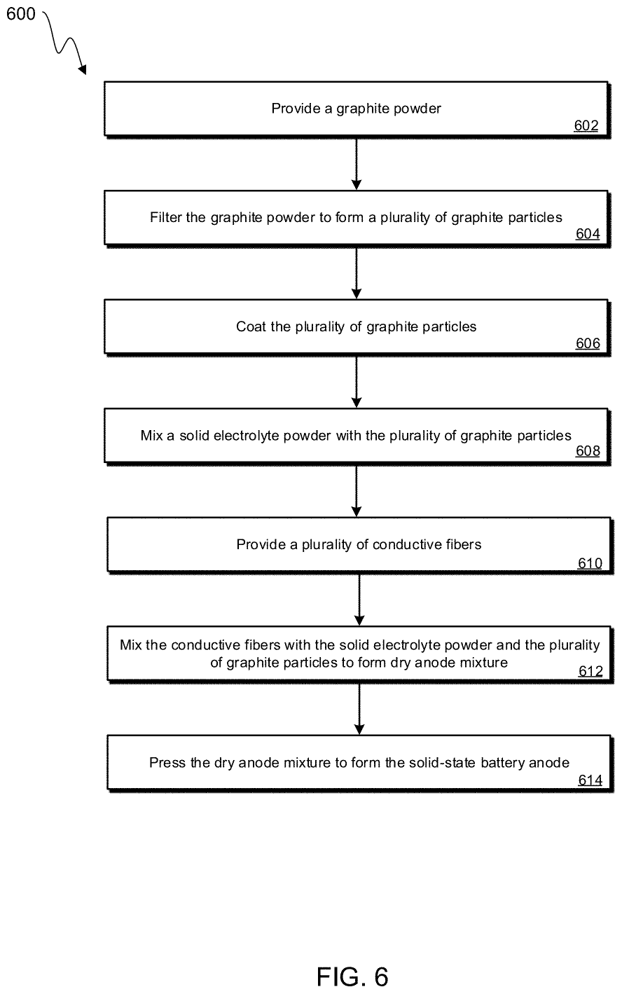

Low-crystallinity carbons may be used for coating 422 because of influence of crystallinity on mutual ion diffusion. Mutual ion diffusion between the graphite particles 410 and the solid-state electrolyte 412 may occur as part of interfacial reactions 420. Thus, reducing or impeding ion diffusion may reduce interfacial reactions 420. Ion diffusion may decrease as the crystallinity of the interface decreases because ions, may stick or become impeded within amorphous (less crystalline) structures, hindering ion conductivity. However, reducing all ion diffusion at the interface may not be desirable because reduced ion diffusion may increase interfacial resistivity by impeding intercalation of the lithium ions 120 into and out of the solid-state battery anode 408 B. Accordingly, coating 422 may have a low crystallinity structure that is not quite amorphous. Low crystallinity may mean that the microstructure of coating 422 is not completely crystalline but not amorphous either. Further details regarding coating 422 are provided with relation to FIG. 6.

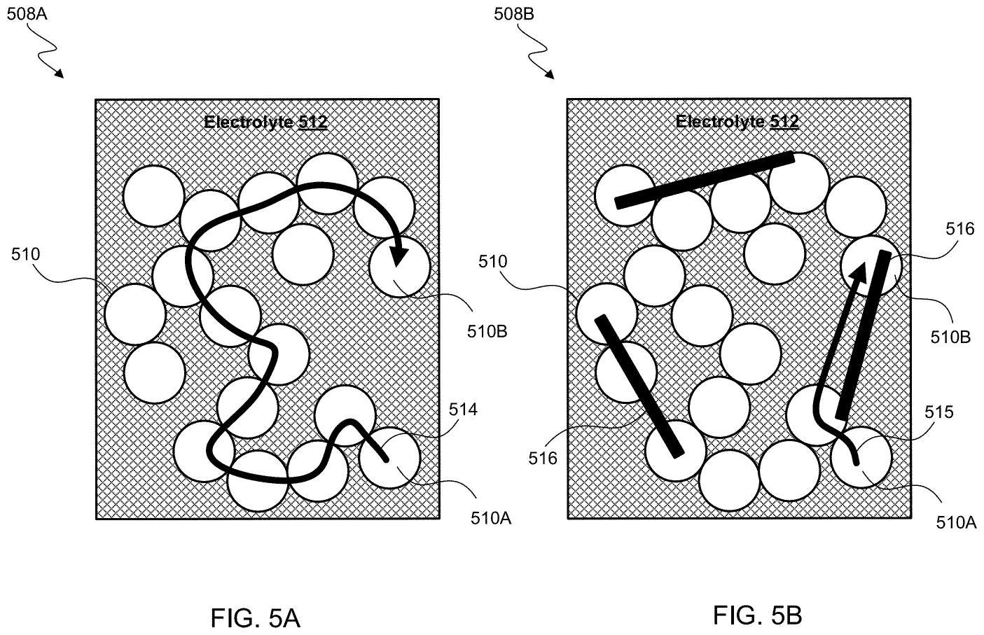

FIG. 5A illustrates an electron pathway 514 through solid-state battery anode 508A. Solid-state battery anode 508A may include a plurality of graphite particles 510 and electrolyte 512. The plurality of graphite particles 510 may be the same as graphite particles 410 and/or graphite particles 310. Electrolyte 512 may be a solid-state electrolyte, such as solid-state electrolyte 412 and/or solid-state electrolyte 312.

Electron pathway 514 may illustrate one pathway that electricity or electrons 122 may take through solid-state battery anode 508 A. Because electrolyte 512 inhibits transmission of electrons 122, electrons 122 transferring into and out of solid-state battery anode 508A during charging and discharging cycles may follow a route formed along the graphite particles 510. For example, for electrons 122 at graphite particle 510A to transfer to graphite particle 510B, the electrons 122 may take electron pathway 514. Because electron pathway 514 may cover a greater distance than a direct point-to-point distance between graphite particle 510A and graphite particle 510B, electrical resistance within solid-state battery anode 508A may be increased.

To reduce electrical resistivity and increase electrical conductivity of a solid-state anode, conductive fibers may be added to the anode material. FIG. 5B illustrates a solid-state battery anode 508B having an anode material including conductive fibers 516. Solid-state battery anode 508B may include an anode material comprising a plurality of graphite particles 510, electrolyte 512, and conductive fibers 516. The conductive fibers 516 may include carbon fibers or graphite fibers. For example, conductive fibers 516 may be vapor grown carbon fibers. Conductive fibers 516 may be interspersed between the plurality of graphite particles 510. In some embodiments, conductive fibers 516 may contact and extend between the graphite particles 510 such to provide shorter electron pathway 515 for electrons 122. For example, electrons 122 at graphite particle 510A in FIG. 5B may have a shorter path to graphite particle 510B along electron pathway 515. Instead of following electron pathway 514 illustrated in FIG. 5A between graphite particle 510A and graphite particle 510B, electrons 122 may follow electron pathway 515 created by conductive fiber 516. By shortening the electron pathway, the electrical resistance within solid-state battery anode 508B may be reduced due to formation of a conductive network.

Conductive fibers 516 may form a conductive network within solid-state battery anode 508B by creating “bridges” between graphite particles 510 for electron transmission. To form a conductive network, at least 25% of the graphite particles 510 may be contacted by conductive fibers 516. For example, at least 30% of the graphite particles 510, at least 40% of the graphite particles, at least 50% of the graphite particles, at least 60% of the graphite particles, at least 70% of the graphite particles, at least 80% of the graphite particles, at least 90% of the graphite particles, at least 95% of the graphite particles, or at least 98% of the graphite particles may be contacted by conductive fibers 516.

FIG. 6 illustrates a flowchart 600 of a method of making a solid-state battery anode, according to some embodiments as provided herein. The method may include providing a graphite powder at step 602. The graphite powder may include a plurality of particles having various particle sizes. For example, graphite powder may include large particles, such graphite particles 306, and small particles, such as graphite particles 310. At step 604, the graphite powder may be filter to form a plurality of graphite particles. Filtering the graphite powder may include sieving the graphite powder to remove large particles. In some embodiments, the graphite powder may be filter such that the plurality of graphite particles have a set diameter. For example, the plurality of graphite particles formed at step 604 may be characterized by a D50 diameter of less than 20 μm. In some embodiments, the plurality of graphite particles may be the same as the plurality of graphite particles 310.

The method may also include coating the plurality of graphite particles, at step 606. Coating the plurality of graphite particles may include spray coating, electro-static coating, wet coating, or any other known means of coating the plurality of graphite particles. In some embodiments, coating the plurality of graphite particles may include spraying a coating solution onto the graphite particles. The coating solution may include LiOh, Zr(t-BuO)₄, and/or an ethanol solution. An exemplary coating solution may include Powerex MP-1. In some embodiments, coating the plurality of graphite particles may include spray coating the plurality of graphite particles in a fluidized bed.

At step 608, a solid electrolyte powder may be mixed with the plurality of graphite particles to form an anode material. In some embodiments, the solid electrolyte powder may be mixed with the plurality of graphite particles before the graphite particles are coated, while in other embodiments, the solid electrolyte powder may be mixed with the plurality of graphite particles after the graphite particles are coated. The solid electrolyte powder may be a solid-state electrolyte. For example, the solid electrolyte powder may be the same as solid-state electrolyte 212, solid-state electrolyte 312, solid-state electrolyte 412, and/or electrolyte 512.

In some embodiments, mixing the solid electrolyte powder with the plurality of graphite particles may include dissolving the solid electrolyte powder in an electrolyte solvent to form an electrolyte solution. The electrolyte solvent may be an anhydrous N-methylformamide solution. The concentration of the solid electrolyte powder in the electrolyte solution may vary. In some embodiments, the concentration of solid electrolyte powder in the electrolyte solution may range from about 5 mol % to about 50 mol %. For example, the concentration of solid electrolyte powder in the electrolyte solution may range from about 10 mol % to about 50 mol %, from about 15 mol % to about 50 mol %, from about 20 mol % to about 50 mol %, from about 25 mol % to about 50 mol %, from about 30 mol % to about 50 mol %, from about 35 mol % to about 50 mol %, from about 40 mol % to about 50 mol %, from about 45 mol % to about 50 mol %, from about 5 mol % to about 45 mol %, from about 10 mol % to about 45 mol %, from about 15 mol % to about 45 mol %, from about 20 mol % to about 45 mol %, from about 25 mol % to about 45 mol %, from about 30 mol % to about 45 mol %, from about 35 mol % to about 45 mol %, from about 40 mol % to about 45 mol %, from about 5 mol % to about 40 mol %, from about 10 mol % to about 40 mol %, from about 15 mol % to about 40 mol %, from about 20 mol % to about 40 mol %, from about 25 mol % to about 40 mol %, from about 30 mol % to about 40 mol %, from about 35 mol % to about 40 mol %, from about 5 mol % to about 35 mol %, from about 10 mol % to about 35 mol %, from about 15 mol % to about 35 mol %, from about 20 mol % to about 35 mol %, from about 25 mol % to about 35 mol %, from about 30 mol % to about 35 mol %, from about 5 mol % to about 30 mol %, from about 10 mol % to about 30 mol %, from about 15 mol % to about 30 mol %, from about 20 mol % to about 30 mol %, from about 25 mol % to about 30 mol %, from about 5 mol % to about 25 mol %, from about 10 mol % to about 25 mol %, from about 15 mol % to about 25 mol %, from about 20 mol % to about 25 mol %, from about 5 mol % to about 20 mol %, from about 10 mol % to about 20 mol %, from about 15 mol % to about 20 mol %, from about 5 mol % to about 15 mol %, from about 10 mol % to about 15 mol %, or from about 5 mol % to about 10 mol %.

After the solid electrolyte powder is dissolved into the electrolyte solvent to form the electrolyte solution, the graphite particles may be soaked in the electrolyte solution to form the anode solution. The graphite particles may be soaked for a duration of time ranging from about 1 minutes to about 24 hours. For example, the graphite particles may be soaked from about 5 minutes to about 24 hours, from about 10 minutes to about 24 hours, from about 15 minutes to about 24 hours, from about 30 minutes to about 24 hours, from about 1 hour to about 24 hours, from about 3 hours to about 24 hours, from about 6 hours to about 24 hours, from about 8 hours to about 24 hours, from about 12 hours to about 24 hours, from about 18 hours to about 24 hours, from about 1 minute to about 18 hours, from about 5 minutes to about 18 hours, from about 10 minutes to about 18 hours, from about 15 minutes to about 18 hours, from about 30 minutes to about 18 hours, from about 1 hour to about 18 hours, from about 3 hours to about 18 hours, from about 6 hours to about 18 hours, from about 8 hours to about 18 hours, from about 12 hours to about 18 hours, from about 1 minute to about 12 hours, from about 5 minutes to about 12 hours, from about 10 minutes to about 12 hours, from about 15 minutes to about 12 hours, from about 30 minutes to about 12 hours, from about 1 hour to about 12 hours, from about 3 hours to about 12 hours, from about 6 hours to about 12 hours, from about 8 hours to about 12 hours, from about 1 minute to about 8 hours, from about 5 minutes to about 8 hours, from about 10 minutes to about 8 hours, from about 15 minutes to about 8 hours, from about 30 minutes to about 8 hours, from about 1 hour to about 8 hours, from about 3 hours to about 8 hours, from about 6 hours to about 8 hours, from about 1 minute to about 6 hours, from about 5 minutes to about 6 hours, from about 10 minutes to about 6 hours, from about 15 minutes to about 6 hours, from about 30 minutes to about 6 hours, from about 1 hour to about 6 hours, from about 3 hours to about 6 hours, from about 1 minute to about 3 hours, from about 5 minutes to about 3 hours, from about 10 minutes to about 3 hours, from about 15 minutes to about 3 hours, from about 30 minutes to about 3 hours, from about 1 hour to about 3 hours, from about 1 minute to about 1 hour, from about 5 minutes to about 1 hour, from about 10 minutes to about 1 hour, from about 15 minutes to about 1 hour, from about 30 minutes to about 1 hour, from about 1 minute to about 30 minutes, from about 5 minutes to about 30 minutes, from about 10 minutes to about 30 minutes, from about 15 minutes to about 30 minutes, from about 1 minute to about 15 minutes, from about 5 minutes to about 15 minutes, from about 10 minutes to about 15 minutes, from about 1 minute to about 10 minutes, from about 5 minutes to about 10 minutes, or from about 1 minute to about 5 minutes.

After the graphite particles soak in the anode solution, the anode solution may be dried. The anode solution may be dried using known techniques, such as for example, in a drying oven. In other embodiments, the anode solution may be dried by sitting at ambient conditions until the anode solution is dried.

In some embodiments, the anode material may also include a plurality of conductive fibers. At step 610, a plurality of conductive fibers may be provided. In some embodiments, the conductive fibers may be mixed with the graphite particles before the graphite particles are mixed with the solid electrolyte powder. While in other embodiments, the conductive fibers may be mixed with the solid electrolyte powder before the graphite particles are mixed with the solid electrolyte powder. In some cases, method 600 may not include step 610 and no conductive fibers may be included in the anode material. The conductive fibers provided at step 610 may be the same as conductive fibers 516.

Once provided, the conductive fibers may be mixed with the solid electrolyte powder and the plurality of graphite particles to form a dry anode mixture at step 612. In some embodiments, the dry anode material may include one or more additional components. For example, the dry anode material may include a binder or an additive The amount of solid electrolyte powder, the amount of graphite particles, and the amount of conductive fibers in the dry anode mixture may vary. In some embodiments, the dry anode mixture may include at least 5% by wt. solid electrolyte powder. For example, the dry anode mixture may include at least 6% by wt., at least 7% by wt., at least 8% by wt., at least 9% by wt., at least 10% by wt., at least 11% by wt., at least 12% by wt., at least 13% by wt., at least 14% by wt., at least 15% by wt., at least 16% by wt., at least 17% by wt., at least 18% by wt., at least 19% by wt., at least 20% by wt., at least 21% by wt., at least 22% by wt., at least 23% by wt., at least 24% by wt., at least 25% by wt., at least 26% by wt., at least 27% by wt., at least 28% by wt., at least 29% by wt., at least 30% by wt., at least 31% by wt., at least 32% by wt., at least 33% by wt., at least 34% by wt., at least 35% by wt., at least 36% by wt., at least 37% by wt., at least 38% by wt., at least 39% by wt., at least 40% by wt., at least 41% by wt., at least 42% by wt., at least 43% by wt., at least 44% by wt., at least 45% by wt., at least 46% by wt., at least 47% by wt., at least 48% by wt., at least 49% by wt., or at least 50% by wt. solid electrolyte powder.

In some embodiments, the dry anode mixture may include at least 50% by wt. graphite particles. For example, the dry anode mixture may include at least 51% by wt., at least 52% by wt., at least 53% by wt., at least 54% by wt., at least 55% by wt., at least 56% by wt., at least 57% by wt., at least 58% by wt., at least 59% by wt., at least 60% by wt., at least 61% by wt., at least 62% by wt., at least 63% by wt., at least 64% by wt., at least 65% by wt., at least 66% by wt., at least 67% by wt., at least 68% by wt., at least 69% by wt., at least 70% by wt., at least 71% by wt., at least 72% by wt., at least 73% by wt., at least 74% by wt., at least 75% by wt., at least 76% by wt., at least 77% by wt., at least 78% by wt., at least 79% by wt., at least 80% by wt., at least 81% by wt., at least 82% by wt., at least 83% by wt., at least 84% by wt., at least 85% by wt., at least 86% by wt., at least 87% by wt., at least 88% by wt., at least 89% by wt., at least 90% by wt., at least 91% by wt., at least 92% by wt., at least 93% by wt., at least 94% by wt., at least 95% by wt., at least 96% by wt., at least 97% by wt., at least 98% by wt., at least 99% by wt., or, in some cases, 100% by wt. graphite particles.

The dry anode mixture may include up to 20% by wt. conductive fibers. For example, the dry anode mixture may include up to 19% by wt., up to 18% by wt., up to 17% by wt., up to 16% by wt., up to 15% by wt., up to 14% by wt., up to 13% by wt., up to 12% by wt., up to 11% by wt., up to 10% by wt., up to 9% by wt., up to 8% by wt., up to 7% by wt., up to 6% by wt., up to 5% by wt., up to 4% by wt., up to 3% by wt., up to 2% by wt., or up to 1% by wt. conductive fibers. In some embodiments, the dry anode mixture may not include any conductive fibers.

At step 614, the dry anode mixture may be pressed to form a solid-state battery anode. In some embodiments, a preparation machine may be used to press and prepare the dry anode mixture to form the solid-state battery anode. For example, a mechanical milling machine may be used. The formed solid-state battery anode from the dry anode mixture may be the same as solid-state battery anode 208, 308B, 408B, and/or 508B.

It should be appreciated that the specific steps illustrated in FIG. 6 provide particular methods of making a solid-state battery according to various embodiments. Other sequences of steps may also be performed according to alternative embodiments. For example, alternative embodiments of the present invention may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize many variations, modifications, and alternatives.

The solid-state battery anodes as provided herein may have improved mechanical, chemical, electrical, and electrochemical properties. For example, the solid-state battery anodes may have improved discharge capacity and increased initial coulombic efficiency. The solid-state battery anode as described may be part of a half-cell assembly. When part of a half-cell assembly, the solid-state battery anode according to some embodiments herein, may have a discharge capacity greater than about 200 MAh/g. For example, the solid-state battery anode may have a discharge capacity of about 205 MAh/g, about 210 MAh/g, about 215 MAh/g, about 220 MAh/g, about 225 MAh/g, about 230 MAh/g, about 235 MAh/g, about 240 MAh/g, about 245 MAh/g, about 250 MAh/g, about 255 MAh/g, about 260 MAh/g, about 265 MAh/g, about 270 MAh/g, about 275 MAh/g, about 280 MAh/g, about 285 MAh/g, about 290 MAh/g, about 295 MAh/g, about 300 MAh/g, 305 MAh/g, about 310 MAh/g, about 315 MAh/g, about 320 MAh/g, about 325 MAh/g, about 330 MAh/g, about 335 MAh/g, about 340 MAh/g, about 345 MAh/g, about 350 MAh/g, about 355 MAh/g, about 360 MAh/g, about 365 MAh/g, about 370 MAh/g, about 375 MAh/g, about 380 MAh/g, about 385 MAh/g, about 390 MAh/g, about 395 MAh/g, about 400 MAh/g, 405 MAh/g, about 410 MAh/g, about 415 MAh/g, about 420 MAh/g, about 425 MAh/g, about 430 MAh/g, about 435 MAh/g, about 440 MAh/g, about 445 MAh/g, about 450 MAh/g, about 455 MAh/g, about 460 MAh/g, about 465 MAh/g, about 470 MAh/g, about 475 MAh/g, about 480 MAh/g, about 485 MAh/g, about 490 MAh/g, about 495 MAh/g, or about 500 MAh/g.

The solid-state battery anode as part of a half-cell assembly may have an initial coulombic efficiency greater than 50%. Initial coulombic efficiency is the amount of lithium ions that deintercalate from the electrode during a discharging cycle over the initial amount of lithium ions that were intercalated into the electrode during an initial charging cycle. The solid-state battery anode as part of a half-cell assembly may have an initial coulombic efficiency greater than 51%, greater than 52%, greater than 53%, greater than 54%, greater than 55%, greater than 56%, greater than 57%, greater than 58%, greater than 59%, greater than 60%, greater than 61%, greater than 62%, greater than 63%, greater than 64%, greater than 65%, greater than 66%, greater than 67%, greater than 68%, greater than 69%, greater than 70%, greater than 71%, greater than 72%, greater than 73%, greater than 74%, greater than 75%, greater than 76%, greater than 77%, greater than 78%, greater than 79%, greater than 80%, greater than 81%, greater than 82%, greater than 83%, greater than 84%, greater than 85%, greater than 86%, greater than 87%, greater than 88%, greater than 89%, greater than 90%, greater than 91%, greater than 92%, greater than 93%, greater than 94%, greater than 95%, greater than 96%, greater than 97%, greater than 98%, greater than 99%, or near 100%.

### EXAMPLE 1

The following Table 1 provides data gathered from an example sample of the solid-state battery anode as provided herein as compared to three comparative solid-state battery anodes. To prepare Table 1, a half-cell assembly was prepared using the solid-state battery anode samples. Table 1 includes four samples: (1) Example 1, (2) Comparative Example 1, (3) Comparative Example 2, and (4) Comparative Example 3.

Example 1 is an example sample of the solid-state battery anode in accordance with the present disclosure. The anode material for Example 1 was prepared using PG-llC graphite particles from Long Time Tech. These graphite particles contain MCMB. The graphite particles had a D50 diameter of 18.3 μm. The anode material for Example 1 also included a solid electrolyte powder and conductive fibers. The solid electrolyte powder included LPS and the conductive fibers included vapor grown carbon fibers manufactured by ShowDenko. The composition of the anode material used to form the solid-state battery anode included 70 wt. % graphite particles, 28 wt. % solid electrolyte powder, and 2 wt. % conductive fibers.

Comparative Example 1 is a solid-state battery anode having large particles sizes, such as those describe with respect to FIG. 3A. The anode material for Comparative Example 1 was prepared using MCMB graphite particles from JFEC. These graphite particles had a D50 diameter of 24.1 μm. The anode material for Comparative Example 1 also included a solid electrolyte powder and conductive fibers. The solid electrolyte powder included LPS. And the conductive fibers included vapor grown carbon fibers manufactured by ShowDenko. The composition of the anode material used to form the solid-state battery anode included 70 wt. % graphite particles, 28 wt. % solid electrolyte powder, and 2 wt. % conductive fibers.

Comparative Example 2 is a solid-state battery anode having graphite particles comprising SMG-A5 from Hitachi Chemicals. The anode material for Comparative Example 2 was prepared using graphite particles that do not include MCMB. These graphite particles had a D50 diameter of 18.5 μm. The anode material for Comparative Example 2 also included a solid electrolyte powder and conductive fibers. The solid electrolyte powder included LPS and the conductive fibers included vapor grown carbon fibers manufactured by ShowDenko. The composition of the anode material used to form the solid-state battery anode included 70 wt. % graphite particles, 28 wt. % solid electrolyte powder, and 2 wt. % conductive fibers.

Comparative Example 3 is a solid-state battery anode formed without conductive fibers. The anode material for Comparative Example 3 was prepared using PG-11C graphite particle from Long Time Tech which include MCMB. These graphite particles had a D50 diameter of 18.3 μm. The anode material for Comparative Example 3 also included a solid electrolyte powder. The solid electrolyte powder included LPS. The composition of the anode material used to form the solid-state battery anode included 70 wt. % graphite particles and 30 wt. % solid electrolyte powder. The solid-state battery anode for Comparative Example 3 did not include conductive fibers.

For each of the above examples, a solid-state battery anode was prepared in accordance with the method provided in FIG. 6. The prepared solid-state battery anodes were added to a solid-state electrolyte separator to form a half-cell assembly for each example. The solid-state electrolyte separator included LGPS and had a thickness of 600 μm. To prevent decomposition of the solid-state electrolyte separator at the interface (due to the lack of a cathode), a counter electrode was used. The counter electrode included indium-lithium (In—Li).

Once the half-cell assembly was prepared, each sample was subjected to a series of charging cycles and discharging cycles to determine a discharge capacity and initial coulombic efficiency. The discharge capacity is the amount of electric charge that the solid-state battery anode can deliver at a rated voltage during a discharging cycle. The initial coulombic efficiency is the discharging coulombic amount over the charging coulombic amount. Using the charging-discharge capacity of the graphite particles as used in conventional lithium-ion batteries, 1C current was calculated and each half-cell assembly was charged and discharged as follows. For the charging cycle (initial lithium-doping of the graphite particles), a constant current of 0.05C was applied to the half-cell assembly until a voltage of −0.6V was reached. Then a constant charging voltage was applied until current decay reached 0.025C. For the discharging cycle (subsequent lithium-undoping from the graphite particles), a constant current of 0.05C was discharged until the voltage reached 1.0V.

TABLE 1

| | | Particle | Anode | Discharge | Initial |
|---|---|---|---|---|---|
| | | D50 | Material | Capacity | Coulombic |
| | Graphite | Diameter | Compo- | (mAh/g @ | Efficiency |
| Sample | Particles | (μm) | sition | 0.05 C) | (%) |
| Example 1 | MCMB | 18.3 | 70:28:2 | 271 | 54.4 |
| Comparative | MCMB | 24.1 | 70:28:2 | 194 | 46.6 |
| Example 1 | | | | | |
| Comparative | SMG-A5 | 18.5 | 70:28:2 | 190 | 41.3 |
| Example 2 | | | | | |
| Comparative | MCMB | 18.3 | 70:30 | 205 | 38 |
| Example 3 | | | | | |

By comparing Example 1 and Comparative Example 1, the effect of the graphite particle size on discharge capacity and initial coulombic efficiency can be highlighted. The D50 diameter for the graphite particles in Comparative Example 1 was 24.1 μm. In contrast the D50 diameter for the graphite particles in Example 1 was 18.3 μm. The rest of the composition of the solid-state battery anodes for Example 1 and Comparative Example 2 remained the same.

As show in Table 1, the larger size of the graphite particles in Comparative Example 1 resulted in more than a 28% reduction in discharge capacity and almost a 15% reduction in initial coulombic efficiency. The discharge capacity of Comparative Example 1 was 194 mAh/g at 0.05C, while the discharge capacity of Example 1 was 271 mAh/g at 0.05C. The initial coulombic efficiency of Comparative Example 1 was 46.6%, while the initial coulombic efficiency for Example 1 was 54.4%. As discussed with relation to FIGS. 3A and 3B, particle size impacts the intercalation (doping) of lithium ions into and out of the anode material, during the charging and discharging cycles, respectively. Specifically, the particle size impacts the formation and maintenance of the electrode-electrolyte interface. For example, when the size (diameter) of the graphite particles is over 20 μm, then sustaining intimate interfacial contact between the graphite particles and the solid-state electrolyte becomes more difficult. Impeding intimate interfacial contact may reduce the discharge capacity and initial coulombic efficiency of the solid-state battery anode, as illustrated by the comparison of Example 1 and Comparative Example 1.

By comparing Example 1 and Comparative Example 2, the effect of graphite particles comprising MCMB on discharge capacity and initial coulombic efficiency can be highlighted. In Comparative Example 2 the graphite particles comprised SMG-A5 modified graphite, while the graphite particles in Example 1 included MCMB. The rest of the composition of the solid-state battery anodes for Example 1 and Comparative Example 2 remained the same, including the D50 diameter of the graphite particles.

As show in Table 1, the use of non-MCMB graphite particles in Comparative Example 2 resulted in more than a 29% reduction in discharge capacity and more than a 24% reduction in initial coulombic efficiency. The discharge capacity of Comparative Example 2 was 190 mAh/g at 0.05C, while the discharge capacity of Example 1 was 271 mAh/g at 0.05C. The initial coulombic efficiency of Comparative Example 2 was 41.3%, while the initial coulombic efficiency for Example 1 was 54.4%. The high specific capacity and spherical structure of MCMB graphite particles may provide for higher discharge capacity and initial coulombic efficiency, as illustrated by the comparison of Example 1 and Comparative Example 2. Specifically, the spherical configuration of MCMB may allow for intimate interfacial contact with the solid-state electrolyte and minimize unfavorable side reactions during the charging and discharging cycles.

By comparing Example 1 and Comparative Example 3, the effect of conductive fibers on discharge capacity and initial coulombic efficiency can be highlighted. In Comparative Example 3, the anode material did not include conductive fibers, while the anode material in Example 1 included conductive fibers. The rest of the composition of the solid-state battery anodes for Example 1 and Comparative Example 3 remained the same, including the D50 diameter of the graphite particles.

As show in Table 1, the use of conductive fibers in Example 1 resulted in more than a 24% increase in discharge capacity and more than a 30%increase in initial coulombic efficiency. The discharge capacity of Comparative Example 3 was 205 mAh/g at 0.05C, while the discharge capacity of Example 1 was 271 mAh/g at 0.05C. The initial coulombic efficiency of Comparative Example 1 was 38.0%, while the initial coulombic efficiency for Example 1 was 54.4%. As described in relation to FIGS. 5A and 5B, the use of conductive fibers may decrease interfacial resistivity and ion diffusion impedance, allowing for easier lithium ion movement into and out of the anode material. The formation of a conductive network via conductive fibers may increase the discharge capacity and increase the initial coulombic efficiency of a solid-state battery anode, as illustrated by Table 1.

In the foregoing specification, aspects of the invention are described with reference to specific embodiments thereof, but those skilled in the art will recognize that the invention is not limited thereto. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive. Additionally, for the purposes of explanation, numerous specific details were set forth in the foregoing description in order to provide a thorough understanding of various embodiments of the present invention. It will be apparent, however, to one skilled in the art that embodiments of the present invention may be practiced without some of these specific details. In other instances, well-known structures, components, and methods are shown in illustrative form.

It should be appreciated that that any described range may include a standard deviation of up to 10%percent for either or both of the upper bound and the lower bound of the range. Additionally, when a value is described as either up to a given wt. % or at least a given wt. %, this inherently includes the bounds of 0 wt. % and 100 wt. %, respectively. Similarly, when a value is described in terms of distance, length, or size, if given using the terms ‘at least’ or ‘up to’, the value inherently has a bottom range of 0. Similarly, when a value is described as ‘greater than’ or ‘less than’, the value inherently includes a top bound of 100 (if in units of %) or a bottom bound of 0, respectively.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, the solid-state battery anode or the solid-state battery have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A solid-state battery comprising:
a solid-state battery cathode;
a solid-state battery anode comprising:
a second solid electrolyte powder;
a plurality of graphite particles, wherein the plurality of graphite particles are characterized by a D50 diameter of less than 20 μm;
a solid-state interfacial coating comprising a low-crystallinity carbon, wherein the solid-state interfacial coating is coated onto the plurality of graphite particles; and
a plurality of conductive fibers, wherein the plurality of conductive fibers are interspersed between the plurality of graphite particles within the solid-state battery anode; and
a solid electrolyte separator positioned between the solid-state battery cathode and the solid-state battery anode to form the solid-state battery.

2. The solid-state battery of claim 1, wherein the solid-state battery cathode further comprises:
a first solid electrolyte powder; and
a plurality of cathode particles mixed with the first solid electrolyte powder to form the solid-state battery cathode.

3. The solid-state battery of claim 1, wherein the solid-state battery anode has a thickness from about 15 μm to about 100 μm.

4. The solid-state battery of claim 1, wherein the solid electrolyte separator has a thickness of from about 10 μm to about 100 μm.

5. The solid-state battery of claim 1, wherein the conductive fibers comprise vapor grown carbon fibers.

6. A solid-state battery anode comprising:
a solid electrolyte powder;
a plurality of graphite particles mixed with the solid electrolyte powder to form a solid-state battery anode, wherein the plurality of graphite particles are characterized by a D50 diameter of less than 20 μm;
a solid-state interfacial coating comprising a low-crystallinity carbon, wherein the solid-state interfacial coating is coated on to the plurality of graphite particles to reduce interfacial reactivity between the plurality of graphite particles and the solid electrolyte powder within the solid-state battery anode; and
a plurality of conductive fibers, wherein the plurality of conductive fibers are interspersed between the plurality of graphite particles within the solid-state battery anode.

7. The solid-state battery anode of claim 6, wherein the solid-state battery anode comprises from about 50 wt. % to about 85 wt. % of the plurality of graphite particles.

8. The solid-state battery anode of claim 6, wherein the solid-state battery anode comprises from about 0 wt. % to about 5 wt. % of the plurality of conductive fibers.

9. The solid-state battery anode of claim 6, wherein the solid electrolyte powder consists of at least one of a polymer solid-state electrolyte, an inorganic solid-state electrolyte, or a sulfur based electrolyte.

10. The solid-state battery anode of claim 6, wherein the solid electrolyte powder comprises lithium phosphorus sulfide.

11. The solid-state battery anode of claim 6, wherein the solid-state battery anode comprises from about 10 wt. % to about 40 wt. % of the solid electrolyte powder.

12. The solid-state battery anode of claim 6, wherein the plurality of graphite particles comprises meso-carbon microbeads.

13. The solid-state battery anode of claim 6, wherein the plurality of graphite particles are characterized by a spherical shape.

14. The solid-state battery anode of claim 6, wherein the conductive fibers comprise carbon or graphite fibers.

15. The solid-state battery anode of claim 14, wherein at least 25%of the plurality of graphite particles are contacted by the conductive fibers.

16. The solid-state battery anode of claim 6, wherein the solid-state battery anode in a half-cell assembly has a discharge capacity greater than about 200 mAh/g.

17. The solid-state battery anode of claim 6, wherein the solid-state battery anode in a half-cell assembly has an initial coulombic efficiency greater than about 50%.

18. A method of manufacturing a solid-state battery anode, the method comprising:
providing a graphite powder for a solid-state battery anode;
filtering the graphite powder to form a plurality of graphite particles characterized by a D50 diameter of less than 20 μm;
coating the plurality of graphite particles with a solid-state interfacial coating;
mixing a solid electrolyte powder with the plurality of graphite particles;
providing a plurality of conductive fibers;
mixing the conductive fibers with the solid electrolyte powder and the plurality of graphite particles to form a dry anode mixture; and
pressing the dry anode mixture to form the solid-state battery anode.

19. The method of manufacturing the solid-state battery anode of claim 18, wherein coating the plurality of graphite particles comprises spray coating the plurality of graphite particles with a low-crystallinity carbon in a fluidized bed.

20. The method of manufacturing the solid-state battery anode of claim 18, wherein mixing the solid electrolyte powder with the graphite particles comprises:
dissolving the solid electrolyte powder in a electrolyte solvent to form an electrolyte solution;
soaking the graphite particles in the electrolyte solution to form an anode solution; and
drying the anode solution.
